(19) United States
(12) Patent Application Publication
(10) Pub. No.: US 2009/0317055 A1
(43) Pub. Date: Dec. 24, 2009

(54) RECORDING APPARATUS, TERMINAL APPARATUS AND RECORDING-VIEWING RESERVATION SYSTEM

(76) Inventor: Yohei Iwami, Nara (JP)

Correspondence Address: BIRCH STEWART KOLASCH & BIRCH, PO BOX 747, FALLS CHURCH, VA, 22040-0747, US

(21) Appl. No.: 12/442,040

(22) PCT Filed: Sep. 18, 2007
(86) PCT No.: PCT/JP2007/068040

§ 371 Date: Mar. 19, 2009

(30) Foreign Application Priority Data
Sep. 20, 2006 (JP) 2006-254891

(51) Int. Cl. H04N 5/91

(52) U.S. Cl. 386/83; 386/E05.003

(57) ABSTRACT

The figure is a diagram showing a processing flow between a home recording apparatus 101 and a portable terminal apparatus 102. When a recording reservation is made in the home recording apparatus 101 (S101), the portable terminal apparatus 102 is notified of information regarding the recording reservation (S102). Details of the information regarding the recording reservation will be described later. In the portable terminal apparatus 102, based on the notified information regarding the recording reservation, comparison with a viewable program list retained in itself is performed, and a viewing reservation is made for a recording-reserved program (S103). In the home recording apparatus 101, at a broadcast time of the program, a recording processing is performed based on the recording reservation in S103 (S104). In the portable terminal apparatus 102, at the broadcast time of the recording-reserved program, for example, a user is notified that a viewing time has come (S104), and it is put into a state where the user can perform viewing if the user is available for the viewing (S105). In S104, in the home recording apparatus 101, the recording is started from a broadcast time instant. Thereby, a recording-reserved broadcast program can also be easily viewed even at a remote location.

### TECHNICAL FIELD

The present invention relates to a recording apparatus, a terminal apparatus and a recording-viewing reservation system, and particularly to a technique in which a recorded broadcast program is viewed at a location remote from the recording apparatus.

### BACKGROUND ART

Today, broadcasts have been progressively digitalized. Following a start of a BS digital broadcast in 2000 and a start of a 110° CS digital broadcast in 2002, a digital terrestrial broadcast has been started in three major wide area zones of Kanto, Chukyo and Kinki, in December, 2003. Also in other areas, the digital terrestrial broadcast is sequentially started, and the broadcast in major cities throughout the country is started by the end of 2006.

Furthermore, from April, 2006, a so-called “one-seg” broadcast which is a digital terrestrial broadcast for portable devices has also been started, and viewing thereof is to be enabled in almost everywhere in the country by the end of 2012. However, since preparations of broadcast infrastructures and popularization of digital broadcast receivers are not completed in a short time period, operations thereof are performed in parallel with a conventional analog broadcast in the immediate future. Consequently, in order not to influence analog broadcast viewers, and also in order to promote a shift to the digital broadcast, a so-called simulcast is often performed in which the same program is broadcasted in the same time slot by the digital broadcast and the analog broadcast.

For a recording apparatus which records TV broadcasts, a technique has been considered in which this simulcast is used to more reliably and finely record a program which a user desires to record.

For example, in Patent Document 1, while one program is being recorded, when a reception status of its broadcast wave is degraded, the recording of video without any disturbance is achieved by reception and recording from another broadcast wave in the simulcast.

Patent Document 1: Japanese Unexamined Patent Application Publication No. 2005-354570

### DISCLOSURE OF THE INVENTION

### Problems to be Solved by the Invention

Incidentally, it is conceivable that an act of recording a program is caused by a user's intention that the user desires to view the program. If the user is in an environment where a recording-reserved program can be viewed at a broadcast time thereof, it should be desirable to be able to perform the viewing on the spot. Popularization of the one-seg is highly likely to cause a situation where the recording-reserved program can be viewed at a going-out destination by using a mobile device such as a cellular telephone. Patent Document 1 has not considered such a situation.

In such a situation, it is considerably troublesome for the user to find a program for which a recording reservation has been made at home, from a one-seg program list for a portable terminal apparatus, and perform the viewing in the portable terminal apparatus. In the case of the simulcast, since a broadcast time slot is the same, it can also be said that it is not so troublesome if the broadcast time is remembered. However, even so, an operation for the recording apparatus and an operation for the portable terminal apparatus, that is, two operations are required, which is troublesome.

In addition, in a situation where viewable program broadcast schedules are different between for the recording apparatus at home and for the portable terminal apparatus, such as in the case where a home is in Tokyo while the going-out destination is Hokkaido, first, the broadcast time of the program desired to be viewed needs to be found again, which is more cumbersome.

The present invention has been made in view of the above described problems, and it is an object of the present invention to provide a recording apparatus, a terminal apparatus and a recording reservation viewing system in which a recording-reserved broadcast program can also be easily viewed at a remote location.

### Means for Solving the Problems

According to a viewpoint of the present invention, there is provided a recording apparatus characterized by including a recording-reserving section which makes a recording reservation for a broadcast program; an address managing section which manages an address of the other party destination to which information regarding the recording reservation, which can identify the above described recording-reserved broadcast program, is transmitted; and a recording reservation information transmitting section which transmits the above described information regarding the recording reservation to a device having the address managed by the above described address managing section.

According to the above described recording apparatus, the same program as the recording-reserved program can be viewed at a going-out destination or the like, through a viewing reservation, if necessary.

It is preferable to include a recording section which receives and records the broadcast program based on the above described information regarding the recording reservation; a recorded content storing section which stores the above described recorded broadcast program as a content; a viewing information receiving section which receives viewing information including a viewing status of the above described recorded broadcast program in the above described device having the managed address; and a viewing information reflecting section which performs a processing for reflecting the above described viewing information into the above described stored content based on the above described received viewing information.

On this occasion, it is preferable that if the above described received viewing information includes information meaning a interruption of viewing of the broadcast program, the above described viewing information reflecting section associates the above described information meaning the interruption of the viewing, with the content which is stored in the above described recorded content storing section and is corresponding to the above described broadcast program. Based on a requested content and an interruption time, it is possible to receive at least a part which is at and after the interruption time, of a recorded content, and perform resume-play from a time point when the viewing has been interrupted. Moreover, it is preferable that if the above described received viewing information includes information meaning completion of the viewing of the broadcast program, the above described viewing information reflecting section associates the above described information meaning the completion of the viewing, with the content which is stored in the above described recorded content storing section and is corresponding to the above described broadcast program.

If the above described received viewing information includes the information meaning the completion of the viewing of the broadcast program, the above described viewing information reflecting section can also delete the content which is stored in the above described recorded content storing section and is corresponding to the above described broadcast program. It is convenient in the case where it is considered that the content of which the viewing has been completed does not need to be viewed again.

The above described viewing information reflecting section can also perform a processing for reflecting the above described viewing information into the content which is stored in the above described recorded content storing section and is corresponding to the above described broadcast program, for each transmitter address.

It is convenient to include a content obtaining request receiving section which accepts a request for obtaining the content stored in the above described recorded content storing section; a content obtaining section which obtains the content stored in the above described recorded content storing section, based on the above described received content obtaining request; a content converting section which converts the above described obtained content into a form which is playable in the other party destination which has issued the above described content obtaining request, the form having been previously registered or obtained by the above described content obtaining request receiving section; and a content transmitting section which transmits the above described converted content to the above described other party destination.

According to another viewpoint of the present invention, there is provided a terminal apparatus characterized by including a video displaying and audio outputting section which receives a broadcast program, and displays video or outputs audio of the above described received program; and a viewing reservation creating section which receives information which is capable of identifying the broadcast program and is regarding a recording reservation in a device of a transmitter, and creates a viewing reservation for the above described broadcast program based on the above described information regarding the recording reservation. It is convenient to include a viewing notifying section which notifies a viewer that a viewing time instant has come close, based on the above described created viewing reservation.

It is preferable that the above described recording apparatus and the above described terminal apparatus constitute a recording-viewing reservation system.

According to another viewpoint of the present invention, there is provided a viewing method characterized by including the steps of receiving information regarding a recording reservation, which can identify a broadcast program for which the recording reservation has been made in a recording apparatus; performing comparison with an electronic program list retained in itself, based on the above described information regarding the recording reservation, and making a viewing reservation for the same broadcast program as the recording-reserved program; and at a broadcast time of the above described same broadcast program as the recording-reserved program, annunciating that a viewing time has come. It is put into a state where a user can perform viewing if the user is available for the viewing. On the other hand, in the recording apparatus, recording is started from a broadcast time instant.

Moreover, there is provided a viewing method characterized by including the steps of making a viewing reservation for a program for which a recording reservation has been made in a recording device, in a portable terminal apparatus; while viewing is performed, if the viewing is interrupted, storing a time from the start of the program until the interruption, as a interruption time; issuing a request for a content along with the interruption time, to a recording apparatus; and based on the requested content and the interruption time, the recording apparatus receiving at least a part which is at and after the interruption time, of a recorded content, and performing resume-play from a time point when the viewing has been interrupted. Thereby, resume-viewing is enabled. The present invention may be a program which causes a computer to execute the above described steps.

### ADVANTAGE OF THE INVENTION

According to the present invention, there is an advantage in that the recording-reserved broadcast program can also be easily viewed at the remote location.

### BRIEF DESCRIPTION OF THE DRAWINGS

FIG. 1 is a diagram showing a configuration example of a recording-viewing reservation system according to a first embodiment of the present invention.

FIG. 2 is a diagram showing a processing flow between a home recording apparatus and a portable terminal apparatus according to the present embodiment.

FIG. 3 is a block diagram showing a configuration example of the home recording apparatus according to the present embodiment.

FIG. 4 is a diagram showing a configuration example of the portable terminal apparatus in the present embodiment.

FIG. 5 is a diagram showing an example of an electronic program list to be obtained.

FIG. 6 is a diagram showing a display example of a screen which, after a recording reservation has been made, inquires of a user whether or not to transmit information regarding the recording reservation to the portable terminal apparatus.

FIG. 7 is a diagram showing an example of a recording reservation list.

FIG. 8 is a diagram showing an example of recording reservation information.

FIG. 9 is a diagram showing an example of data managed as transmission destinations.

FIG. 10 is a diagram showing an example of the program list to be obtained.

FIG. 11 is a diagram showing an example of viewing reservation information.

FIG. 12 is a diagram showing a display example of a display screen of the portable terminal apparatus 102 which notifies the user.

FIG. 13 is a flowchart diagram showing a processing flow for making a viewing reservation for a program for which the recording reservation has been made in the home recording apparatus, in the portable terminal apparatus, and performing viewing.

FIG. 14 is a flowchart diagram showing the processing flow for making the viewing reservation for the program for which the recording reservation has been made in the home recording apparatus, in the portable terminal apparatus, and performing the viewing.

FIG. 15 is a diagram showing a processing flow in the case where, while the viewing-reserved program is being viewed in the portable terminal apparatus, the viewing is interrupted.

FIG. 16 is a flowchart diagram showing a processing flow for viewing the program of which the viewing has been interrupted, in the portable terminal apparatus, which is a processing for performing the viewing in a manner different from FIG. 15.

FIG. 17 is a diagram showing a processing flow in the case where the viewing-reserved program is viewed to the end in the portable terminal apparatus.

FIG. 18 is a functional block diagram showing a configuration example of the portable terminal apparatus according to the present embodiment.

FIG. 19 is a diagram showing a configuration example of the home recording apparatus in the present embodiment.

FIG. 20 is a diagram showing an example of a viewable content list which has been stored in a viewable content list storing section in the portable terminal apparatus.

FIG. 21 is a diagram showing an example of information required for a content obtaining request which is created and transmitted by a content obtaining request creating and transmitting section.

FIG. 22 is a diagram showing an example of a display screen of a displaying section which, when the viewing of a recorded content has been completed in the portable terminal apparatus, inquires of the user whether or not to delete the recorded content which has been stored in the home recording apparatus.

FIG. 23 is a diagram showing an example of a screen which displays a table of recorded contents which have been stored in a recorded content storing section in the home recording apparatus.

FIG. 24 is a flowchart diagram in the case where a processing is performed depending on a status of the viewing of the program for which the recording reservation has been made in the home recording apparatus and for which the viewing reservation has been made in the portable terminal apparatus.

FIG. 25 is a diagram showing a configuration example of the home recording apparatus according to a third embodiment of the present invention.

FIG. 26 is a diagram showing a configuration example of the portable terminal apparatus according to the present embodiment.

FIG. 27 is a diagram showing an example of information managed in a transmission destination managing section.

FIG. 28 is a flowchart diagram showing a processing example in the home recording apparatus according to the present embodiment.

### DESCRIPTION OF SYMBOLS

101 . . . home recording apparatus, 102 . . . portable terminal apparatus, 104, 105 . . . broadcast networks, 301 . . . tuner inputting section, 302 . . . program list obtaining section, 303 . . . recording reservation UI section, 304 . . . recording reservation input accepting section, 305 . . . recording reservation list storing section, 306 . . . recording reservation information creating section, 307 . . . recording reservation information transmitting section, 308 . . . communicating section, 309 . . . recording controlling section, 310 . . . recorded content storing section, 311 . . . transmission destination managing section, 401 . . . tuner inputting section, 402 . . . program list obtaining section, 403 . . . communicating section, 404 . . . recording reservation information receiving section, 405 . . . viewing reservation information generating section, 406 . . . viewing reservation information storing section, 407 . . . viewing controlling section, 408 . . . viewing time instant notifying section, 409 . . . program selection displaying section.

### BEST MODE FOR CARRYING OUT THE INVENTION

Hereinafter, embodiments of the present invention will be described by using the drawings, with reference to the drawings.

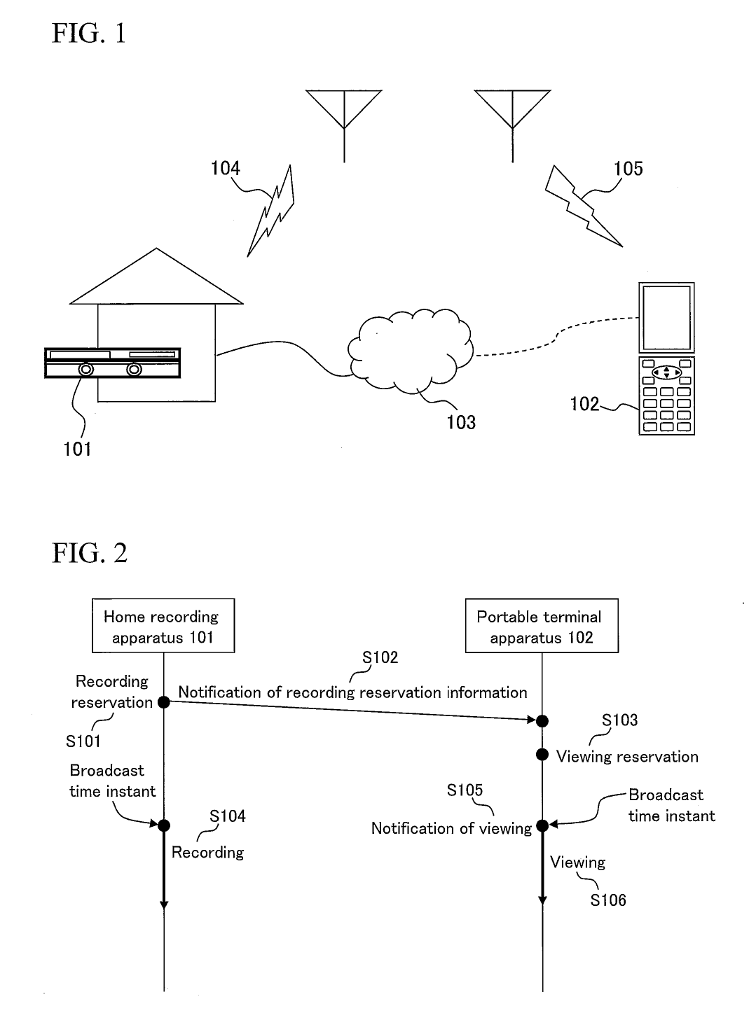

FIG. 1 is a diagram showing a configuration example of a recording-viewing reservation system according to an embodiment of the present invention. As shown in FIG. 1, the recording-viewing reservation system according to the present embodiment is configured so that, for example, a recording apparatus 101 installed at home and a portable terminal apparatus 102 which is brought out to a going-out destination can be connected to each other via a network 103. Both the recording apparatus 101 and the portable terminal apparatus 102 can receive a broadcast wave 104 based on a first TV broadcast and a broadcast wave 105 based on a second TV broadcast, and perform viewing thereof.

The home recording apparatus 101 is, for example, a HDD recorder, a video cassette recorder, a PC with a PC tuner and a recording function, a television with the recording function, or the like, and is an apparatus which can receive various broadcast waves 104 such as terrestrial and satellite, digital and analog broadcasts, and a CS broadcast. The recording-viewing reservation system according to the present embodiment is characterized in that recording reservation information in a home device is transmitted to a portable device and on the basis of the information, a viewing reservation is made in the portable device.

The portable terminal apparatus 102 only has to be able to receive the TV broadcasts and also have a function of connecting to the Internet, and includes a cellular telephone, a PDA, a mobile TV with a network function, a car navigation apparatus with a TV function, a portable game machine and the like. The TV broadcast 105 which can be received may correspond to various broadcasts such as analog and digital terrestrial waves, a satellite wave, and a one-segment broadcast (hereinafter, “one-seg broadcast”) for the portable terminal apparatus. In the present embodiment, the portable terminal apparatus is described as having a function capable of receiving the one-seg broadcast.

The network 103 includes the Internet connection, a LAN connection and the like. A network connection between the home and outside may be configured so that a gateway is installed so as to connect a home network at home and a network outside the home via the Internet.

Under such an environment, the system according to the present embodiment is characterized in that a program for which a recording reservation has been made in the home recording apparatus 101 is automatically set as the viewing reservation in the portable terminal apparatus 102.

FIG. 2 is a diagram showing a processing flow between the home recording apparatus 101 and the portable terminal apparatus 102, according to the present embodiment. When the recording reservation is made in the home recording apparatus 101 (S101), the portable terminal apparatus 102 is notified of information regarding the recording reservation (S102). Details of the information regarding the recording reservation will be described later. In the portable terminal apparatus 102, based on the notified information regarding the recording reservation, comparison with a viewable program list retained in itself is performed, and the viewing reservation is made for the recording-reserved program (S103).

In the home recording apparatus 101, at a broadcast time of the program, a recording processing is performed based on the recording reservation in S103 (S104). In the portable terminal apparatus 102, at the broadcast time of the recording-reserved program, for example, a user is notified that a viewing time has come (S104), and it is put into a state where the user can perform the viewing if the user is available for the viewing (S105). In S104, in the home recording apparatus 101, the recording is started from a broadcast time instant.

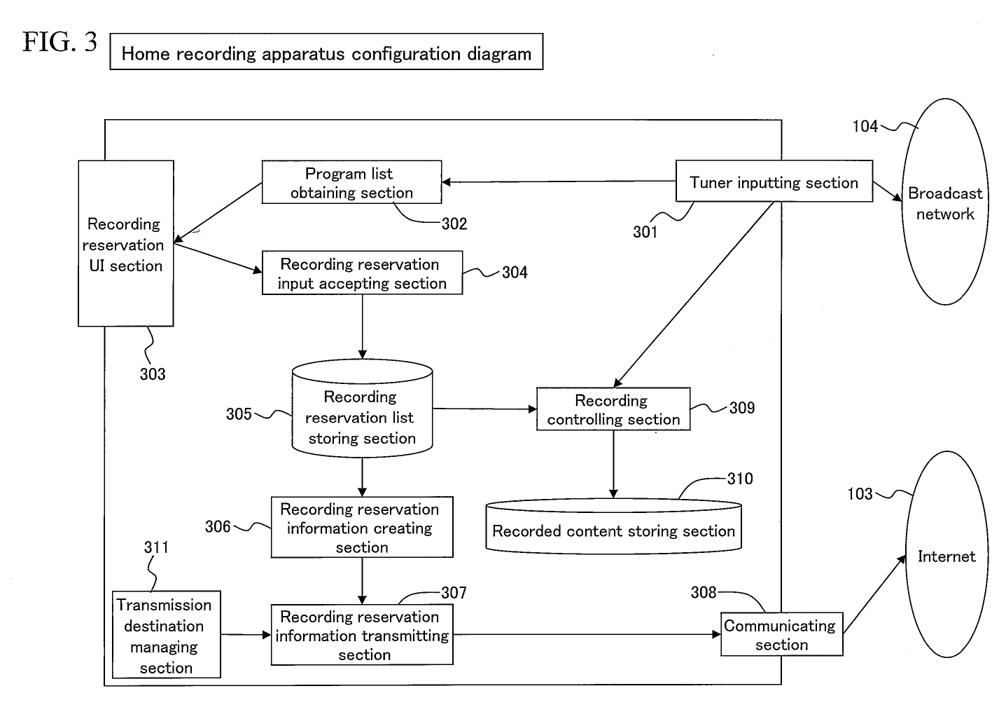

FIG. 3 is a block diagram showing a configuration example of the home recording apparatus 101 according to the present embodiment. A tuner inputting section 301 performs tuning in for receiving a broadcast wave of a desired frequency from the broadcast network 104. Moreover, the tuner inputting section 301 also receives data of an electronic program list which is mixed in the broadcast wave and transmitted. Although at least one tuner inputting section 301 is required for the home recording apparatus 101, a plurality of tuner inputting sections 301 may exist.

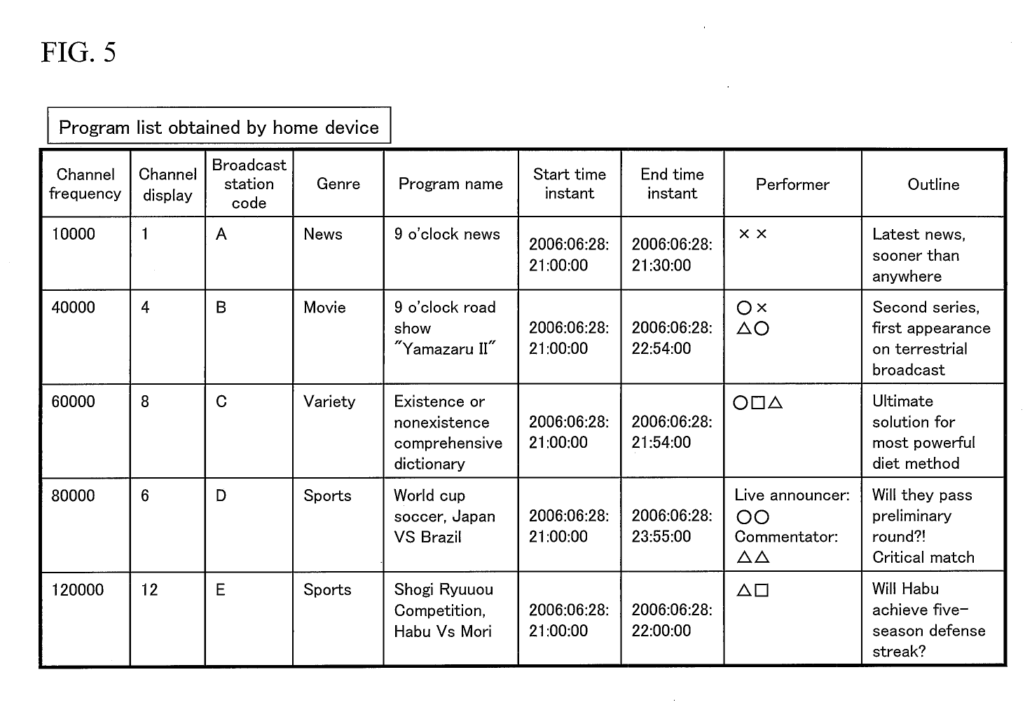

A program list obtaining section 302 obtains the data of the electronic program list from the broadcast wave received by the tuner inputting section 301. The electronic program list refers to an Electronic Program Guide (EPG) or the like. However, the program list obtaining section 302 does not necessarily need to obtain the program list from the broadcast wave, and may connect to a communicating section 308 and obtain the data of the electronic program list via the Internet. An example of the electronic program list to be obtained is shown in FIG. 5. A configuration of FIG. 5 will be described later.

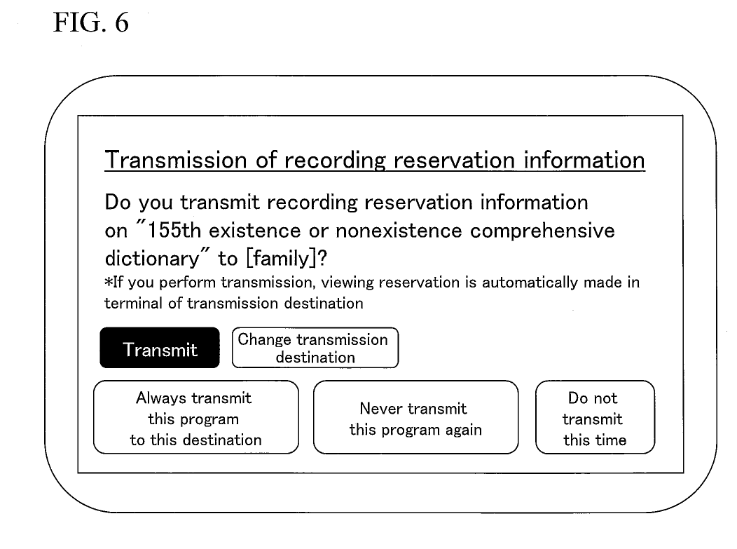

A recording reservation UI section 303 provides a user interface (UI) with which the user can make the recording reservation, based on the electronic program list obtained by the program list obtaining section 302. Examples of the user interface include a user interface which presents the electronic program list to the user in various display forms such as for each time table, for each channel, and for each genre, and in which the recording reservation is made by program selection and decision operations by the user. Moreover, an ID which specifies a program, such as a G-code, may be inputted to allow for making the recording reservation. After the recording reservation has been made, a screen which inquires of the user about whether or not to transmit the information regarding the recording reservation to the portable terminal apparatus 102 is desired to be displayed. An example of the inquiry screen is shown in FIG. 6, and details thereof will be described later.

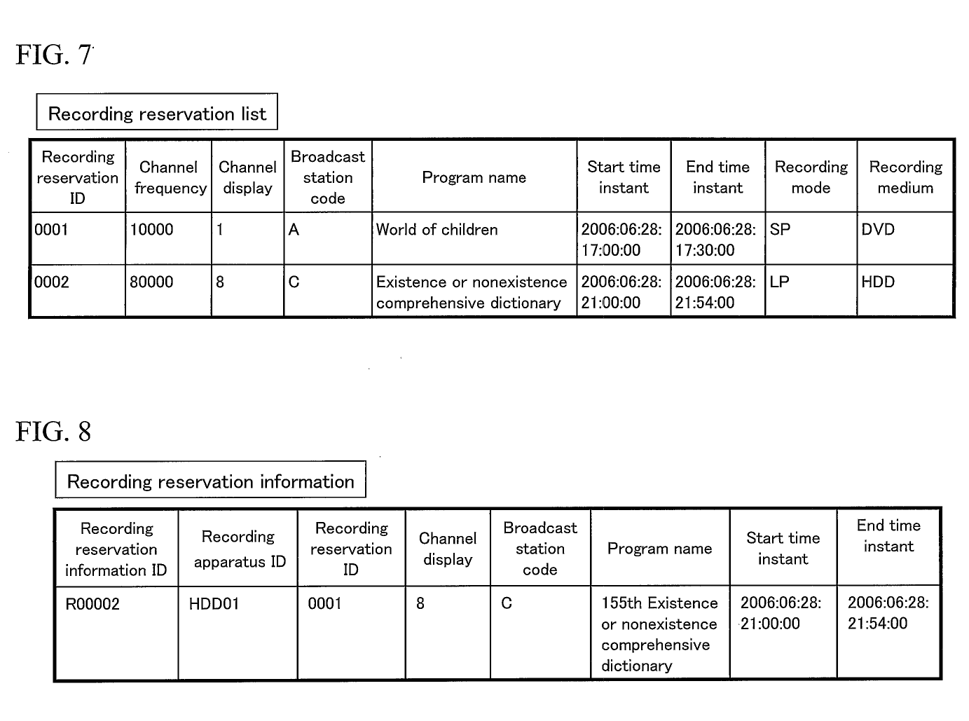

A recording reservation input accepting section 304 receives the information regarding the recording reservation inputted in the recording reservation UI section 303, and stores it in a recording reservation list storing section 305. The information regarding the recording includes not only information described in the electronic program list, but may also include information on a recording mode, a recording medium and the like. An example of the recording reservation list is shown in FIG. 7, and details thereof will be described later. The recording reservation accepted by the recording reservation input accepting section 304 is not only the recording reservation inputted by the user from the recording reservation input accepting section 304, but may also be a recording reservation inputted via the network from the communicating section 308. Moreover, the recording reservation may be made for a program which is automatically selected by a keyword or extraction of user preferences, or the like.

The recording reservation list storing section 305 stores a list of the information for which the recording reservation has been made by the recording input accepting section 304. This recording reservation list does not necessarily need to be stored within the home recording apparatus 101, and for example, a server which controls the recording in the home device may be provided in the home network, and this recording reservation list may be stored in the server. In this case, such information which specifies an apparatus to perform the recording may also be included.

From a recording reservation which has been newly added to the recording reservation list storing section 305, a recording reservation information creating section 306 creates recording reservation information for notifying the portable terminal apparatus 102 (FIG. 1) of this recording reservation. An example of the recording reservation information is shown in FIG. 8, and details thereof will be described later.

A recording reservation information transmitting section 307 attaches information which specifies a transmission destination managed in a transmission destination managing section 311, to the recording reservation information created by the recording reservation information creating section 306, and transmits the recording reservation information to the portable terminal apparatus 102 (FIG. 1) via the communicating section 308. As the information which specifies the transmission destination, for example, an IP address, an email address and the like are conceivable. The communicating section 308 physically connects to the network and performs transmission and reception of various data. A recording controlling section 309 refers to the recording reservation list stored in the recording reservation list storing section 305, and at the broadcast time instant of the recording-reserved program in the list, sets the tuner inputting section 301 to receive the program, and controls it to store a content of the received program in a recorded content storing section 310. The recorded content storing section 310 stores the program which is recorded under the control of the recording controlling section 309.

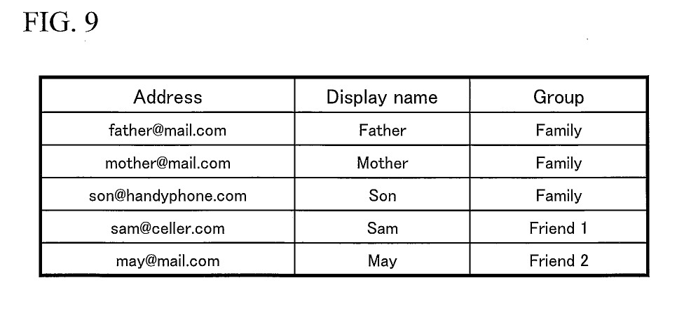

The transmission destination managing section 311 manages the other party destination to which the recording reservation information is transmitted. The user may be able to input a destination to transmit the recording reservation information, or select the transmission destination from a presented list, or select the permission, non-permission or the like based on a UI which is presented so that permission for the transmission can be set for each transmission destination. For example, by default, the transmission may be performed to all transmission destinations which have been registered as the transmission destination. In the case where the recording reservation has been made from the communicating section 308 or the like via the Internet, or the like, the transmission destination may be an address from which the recording reservation has been transmitted. An example of data managed as the transmission destinations is shown in FIG. 9, and details thereof will be described later.

In the present embodiment, although a use case in which a recorded content is viewed in the home recording apparatus 101 is not described in detail, generally, the home recording apparatus 101 also has a function of selecting the recorded content and outputting the recorded content as video and audio signals.

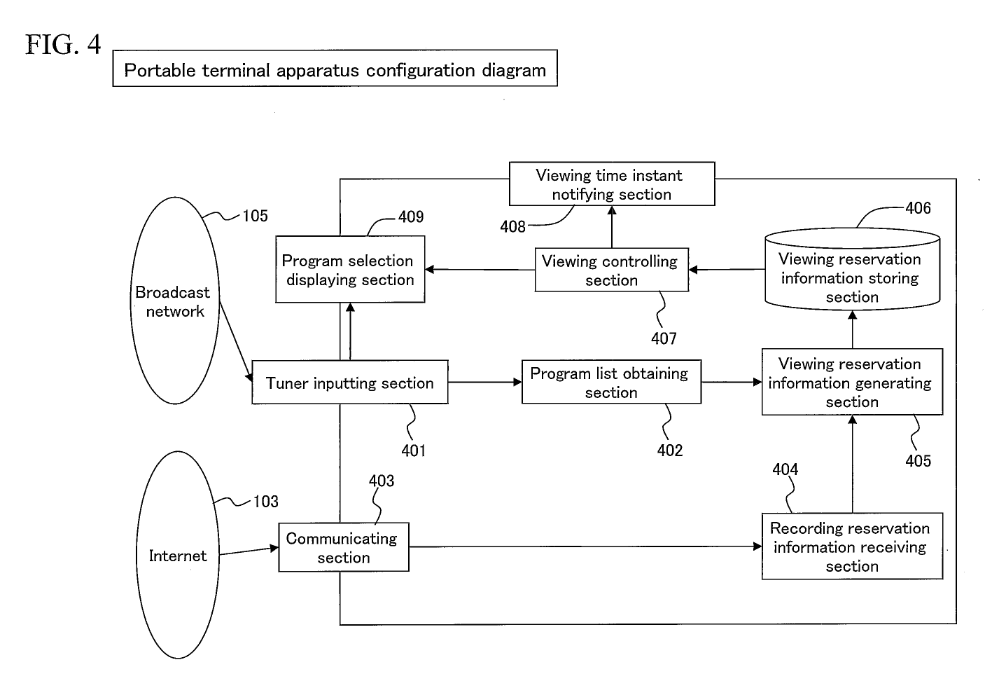

FIG. 4 is a diagram showing a configuration example of the portable terminal apparatus 102 in the present embodiment. A tuner inputting section 401 can receive the broadcast wave of the desired frequency from the broadcast network 105 from which the portable terminal apparatus 102 can perform the receiving. Moreover, the tuner inputting section 401 can also receive the electronic program list data which is mixed in the broadcast wave and transmitted. It should be noted that a plurality of tuner inputting sections 401 may exist.

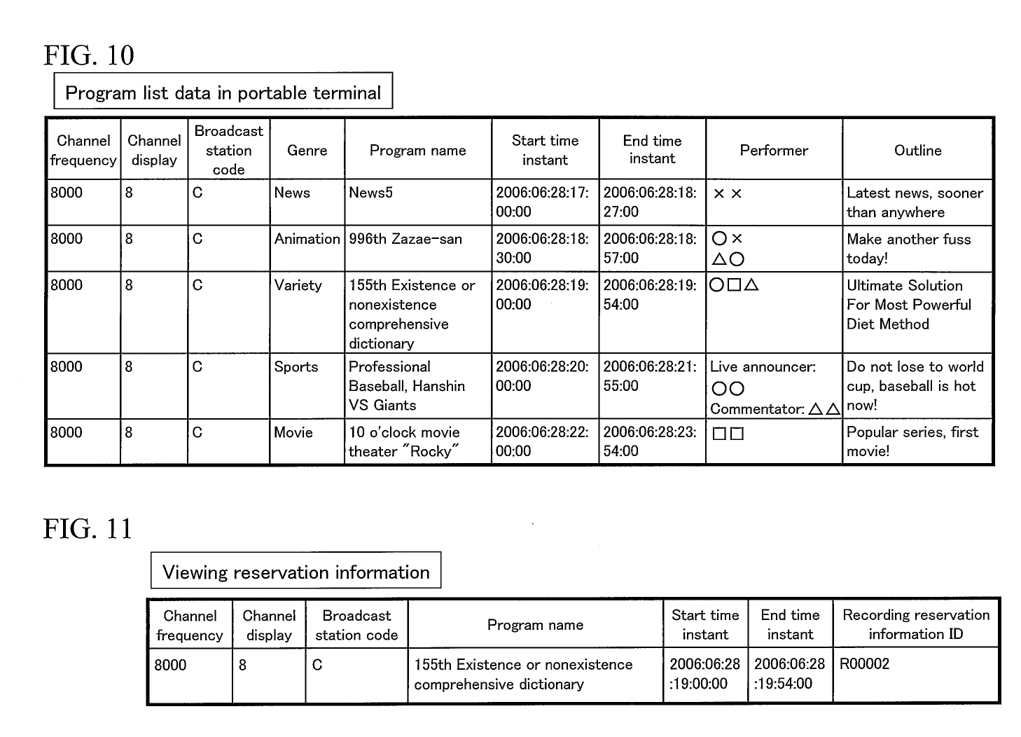

A program list obtaining section 402 obtains the electronic program list data from the broadcast wave received by the tuner inputting section 401. The electronic program list is the EPG or the like. However, the program list obtaining section 402 does not necessarily need to obtain the program list from the broadcast wave, and may connect to the Internet via a communicating section 403 which is separately provided, and obtain the electronic program list data via the Internet. An example of the program list to be obtained is shown in FIG. 10, and details thereof will be described later. The communicating section 403 constitutes an interface section which is physically connected to the network so as to be able to perform the transmission and reception of the various data. A recording reservation information receiving section 404 receives the recording reservation information transmitted from the home recording apparatus 102.

On the basis of the program list obtained by the program list obtaining section 402, a viewing reservation information generating section 405 judges whether or not there is the recording-reserved program included in the recording reservation information received by the recording reservation information receiving section 404, and if there is the recording-reserved program, the viewing reservation information generating section 405 generates viewing reservation information regarding an appropriate program, and stores the viewing reservation information in a viewing reservation information storing section 406. An example of the viewing reservation information is shown in FIG. 11, and details thereof will be described later. The viewing reservation information storing section 406 stores the viewing reservation information generated by the viewing reservation information generating section 405.

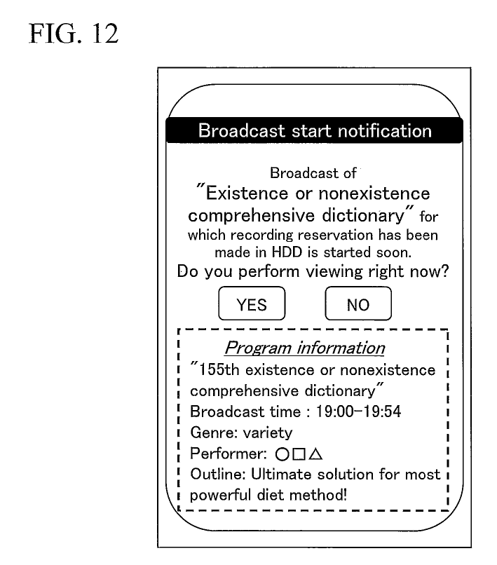

A viewing controlling section 407 refers to the viewing reservation information stored in the viewing reservation information storing section 406, and at the broadcast time of the viewing-reserved program, issues a notification instruction to a viewing time instant notifying section 408 to notify a program selection displaying section 409 of information on a viewed program. At the broadcast time instant of the viewing-reserved program, or immediately before it, the viewing time instant notifying section 408 notifies the user that the program is started. As a way of notification, audio, video, light, vibration, transmission of a reminder email, a combination thereof and the like are conceivable. An example of a notification screen is shown in FIG. 12.

The program selection displaying section 409 sets the tuner inputting section 401 to a frequency of an inputted channel, and receives a broadcast program. Then, video of the received program is displayed or audio thereof is outputted. A channel selection input may be performed by a channel selection operation by the user or automatically performed based on the viewing reservation or the like, and the present embodiment uses the latter case. If, for example, a viewing decision operation by the user is inputted with respect to the viewing-reserved program, based on the information on the program to be viewed which has been notified by the viewing controlling section 407, the tuner inputting section 401 is set to a desired channel, and the viewing-reserved program is displayed. The channel selection input may be automatically performed at the broadcast time, without causing the user to input the viewing decision operation.

FIG. 5 is a diagram showing an example of the electronic program list obtained by the program list obtaining section 302 in the home recording apparatus (FIG. 3). The data includes, for example, a channel frequency, a channel display, a broadcast station ID, a genre, a program name, a start time, an end time, a performer, an outline and the like.

The channel frequency is a frequency set in the tuner inputting section. The channel display is a channel number which is displayed when a broadcast wave of the channel frequency is received and displayed on a TV. The broadcast station ID is an ID which represents a broadcast station broadcasting the program. The genre is a genre of the program, and is, for example, news, movie, sports or the like. The program name is a title of the program. The start time is a time instant when the broadcast of the program is started. The end time is a time instant when the broadcast of the program is completed. In the performer, a main performer in the program has been inputted. In the outline, a highlight or the like of the program has been inputted.

This electronic program list data can be used to display a genre-by-genre program list, a channel-by-channel program list, a time-by-time program list and the like. In addition to items listed here, a program ID which specifies the program, a reduced image representing one scene of the program, or a digest video file or link may be included.

FIG. 6 is a diagram showing an example of a screen which, when the recording reservation has been made, inquires whether or not to notify of the recording reservation. On this screen, a screen which inquires whether or not to transmit “EXISTENCE OR NONEXISTENCE COMPREHENSIVE DICTIONARY” which is an example of the recording-reserved program to a group family is displayed. The user can select any of “TRANSMIT”, “CHANGE TRANSMISSION DESTINATION”, “ALWAYS TRANSMIT THIS PROGRAM TO THIS DESTINATION”, “NEVER TRANSMIT THIS PROGRAM AGAIN” and “DO NOT TRANSMIT THIS TIME”, which are examples of displayed options. For example, as shown in FIG. 6, if “TRANSMIT” is selected, the recording reservation information is transmitted, for example, to all family group members (portable terminal apparatuses) which have been previously registered in the transmission destination managing section 311 (FIG. 3, the same in the followings). If “CHANGE TRANSMISSION DESTINATION” is selected, a list of transmission destination information managed by the transmission destination managing section 311 may be displayed, and an UI with which a destination to which the transmission is performed can be selected from the list may be displayed. In the case where “ALWAYS TRANSMIT THIS PROGRAM TO THIS DESTINATION” is selected, if “EXISTENCE OR NONEXISTENCE COMPREHENSIVE DICTIONARY” is selected from this time, the transmission to the family is inevitably performed.

If “NEVER TRANSMIT THIS PROGRAM AGAIN” is selected, the transmission is not performed from now even if the recording reservation is made for “EXISTENCE OR NONEXISTENCE COMPREHENSIVE DICTIONARY”. If “DO NOT TRANSMIT THIS TIME” is selected, the transmission is not performed this time. However, if the recording reservation is made next time, this screen is displayed once again so as to prompt the user to perform the selection. It should be noted that an UI with which settings can be changed so that the transmission destination or a transmission method is changed even if “DO NOT TRANSMIT THIS TIME”, “ALWAYS TRANSMIT THIS PROGRAM TO THIS DESTINATION” or “NEVER TRANSMIT THIS PROGRAM AGAIN” is selected, is desirably set so that the changing can be performed, for example, from a reservation list table screen.

FIG. 7 is a diagram showing a configuration example of the recording reservation list which has been stored in the recording reservation list storing section 305 (FIG. 3). In the recording reservation list, the information regarding the recording reservation generated by the recording reservation input accepting section 304 (FIG. 3) has been listed. For example, listed items include a recording reservation ID, the channel frequency, a channel, a broadcast station code, a broadcast start time, a broadcast end time, a recording mode, and a target recording medium. The recording reservation ID is an ID which is allocated to each one recording reservation in order to identify the recording reservation. The recording mode represents a mode of image quality of the recording. LP, SP, triple, standard and the like are common. The recording medium is not required as the item if there is only one record medium supported by the home recording apparatus 101. However, if a plurality of record media such as a DVD and an HDD are supported, the recording medium is required so that a medium for recording the reserved program can be set from among them.

In the example shown in FIG. 7, two recordings have been reserved, that is, 1) a recording reservation for recording “WORLD OF CHILDREN” which is to be broadcasted on 1-channel from 17:00 to 17:30 on Jun. 28, 2006, into the DVD in the image quality of SP, and a recording reservation for recording “EXISTENCE OR NONEXISTENCE COMPREHENSIVE DICTIONARY” which is to be broadcasted on 8-channel from 21:00 to 21:54 on Jun. 28, 2006, into the HDD in the LP mode.

The information shown in FIG. 7 can be used to present a recording list and the like to the user. Moreover, if the electronic program list includes information which can uniquely identify the program, such as the program ID, it may be configured so that only the program ID is stored in the recording reservation list, and based on the program ID, with reference to the electronic program list, the display of the reservation list, the recording processing and the like are performed.

FIG. 8 is a diagram showing a configuration example of the recording reservation information created by the recording reservation information creating section 306 (FIG. 3). Included data includes a recording reservation information ID, a recording apparatus ID, the recording reservation ID, the channel display, the broadcast station code, the program name, the start time and the end time. The recording reservation information ID is an ID which is individually allocated to each piece of the recording reservation information. In the portable terminal apparatus 102, this ID is used to cause the viewing reservation to correspond to the recording reservation.

Thus, a device which assigns this ID may be on the home device side or the portable terminal apparatus side. The recording apparatus ID is an ID which identifies the home recording apparatus 101. In the portable terminal apparatus 102, this ID can be used to discriminate which device at home is performing the recording.

The channel display, the broadcast station code and the program name which are included in the recording reservation information are used when the recording list in the home recording apparatus 101 is displayed in the portable terminal apparatus 102, when an appropriate recording-reserved program is searched for from the viewable program list for the portable terminal apparatus 102, and the like.

FIG. 9 is a diagram showing an example of the data managed in the transmission destination managing section 311 in the home recording apparatus (FIG. 3). Here, each contact address (for example, the email address) and each display name (nickname) in the home recording apparatus, and a group name for handling a plurality of transmission destinations as one group, are managed. Of course, in addition to the email address, the address may be an IP address, an SIP address or the like.

FIG. 10 is a diagram showing an example of the electronic program list data obtained by the program list obtaining section 402 in the portable terminal apparatus 102 (FIG. 4). Although only a list for the 8-channel is shown so that the list can be easily used in the following explanation, of course, the data can also be obtained for another channel, and the list can be created therewith. The list shown in FIG. 10 includes the channel display, the broadcast station code, the genre, the program name, the start time and the end time of the broadcast of the program, and other information (for example, the performer, the outline). The user of the portable terminal apparatus 102 can display such data on the displaying section, if necessary.

FIG. 11 is a diagram showing an example of the viewing reservation information generated by the viewing reservation information 405 in the portable terminal apparatus. As shown in FIG. 11, the viewing reservation information includes the information on the program to be viewed, and the corresponding recording reservation information ID. In the example shown in FIG. 11, it can be seen that, as the recording reservation information which is identified by the recording reservation information ID=R00002 and for which the recording reservation has been made in the home device, the viewing reservation has been made for “EXISTENCE OR NONEXISTENCE COMPREHENSIVE DICTIONARY” which is broadcasted on the 8-channel from 19:00 to 19:54 on Jun. 28, 2006, in the portable terminal apparatus.

FIG. 12 is a diagram showing a display example of a display screen, of which the portable terminal apparatus 102 notifies the user. For example, immediately before the broadcast time, a display as shown in FIG. 12 is performed on the displaying section along with the audio or the vibration. According to FIG. 12, when it is notified that the broadcast of “EXISTENCE OR NONEXISTENCE COMPREHENSIVE DICTIONARY” for which the recording reservation has been made in the HDD recorder of the home device is started soon, and the user selects “YES”, the viewing of the program can be started. Moreover, the electronic program list data can be used to display detailed information regarding the program.

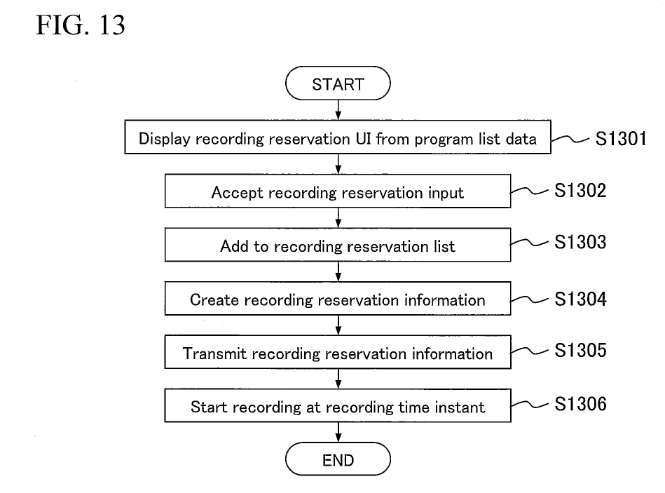

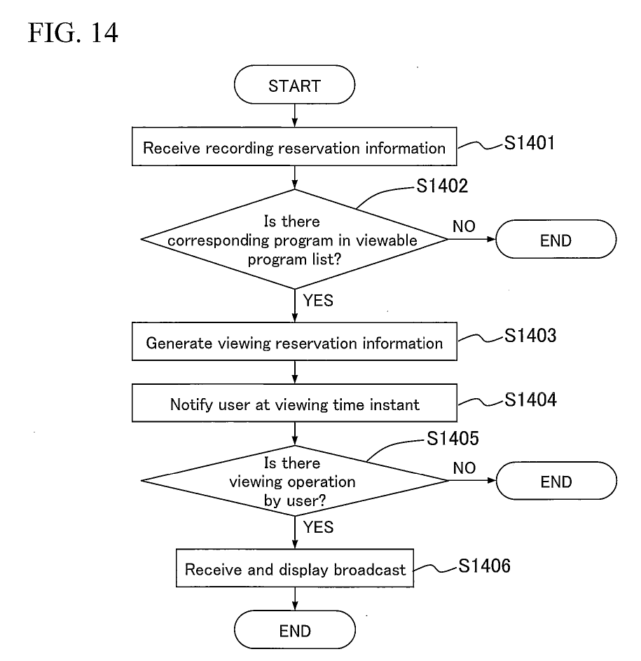

FIGS. 13 and 14 are flowchart diagrams showing a processing flow for making the viewing reservation for the program for which the recording reservation has been made in the home recording apparatus 101, in the portable terminal apparatus 102, and performing the viewing. As explanation of these diagrams, a processing example in the case where the data shown in FIGS. 5 to 11 is used will be described.

FIG. 13 shows a processing for making the recording reservation, generating the recording reservation information, and performing the recording, in the home recording apparatus 101. A processing flow in which the recording reservation is made for “EXISTENCE OR NONEXISTENCE COMPREHENSIVE DICTIONARY” which is broadcasted on the 8-channel from 21:00 to 21:54 on Jun. 28, 2006, on the basis of a program schedule in the viewing reservation information shown in FIG. 11, will be described by way of example. The description is performed also with reference to other figures.

First, the electronic program list data obtained by the program list obtaining section 302 is used to display the recording reservation UI by the recording reservation UI section 303 (S1301). If the program to be recorded is decided and inputted by the user who has referred to this (S1302), the recording reservation information accepting section 304 adds a newly recording-reserved program to the recording reservation list storing section 305 (S1303). As shown in FIG. 7, at a last line of the recording reservation list, “EXISTENCE OR NONEXISTENCE COMPREHENSIVE DICTIONARY” is added. The recording mode of LP and the recording medium of the HDD have been designated. With reference to the added recording reservation list, the recording reservation information generating section 306 adds the recording apparatus ID and the like, and creates the recording reservation information shown in FIG. 8 (S1304).

The recording reservation information transmitting section 307 transmits the created recording reservation information to a destination which is managed by the transmission destination managing section 311 and which identifies the portable terminal apparatus 102 on the network (S1305). In the home recording apparatus 101, at 21:00 on Jun. 28, 2006 which is a recording time, the recording into the HDD with the image quality of LP is started (S1306).

FIG. 14 is a flowchart diagram showing a processing flow in which the recording reservation information transmitted in S1305 of FIG. 13 is received and the user performs the viewing, in the portable terminal apparatus. The recording reservation information receiving section 404 receives recording information from the home recording apparatus 101 via the communicating section 403 (S1401). In the viewing reservation information generating section 405, the program in the recording information received by the recording reservation information receiving section 404 is searched for from the electronic program list data obtained by the program list obtaining section 402 (S1402). When the obtained program list data of the broadcast station C is configured as shown in FIG. 10, it can be seen that 155TH EXISTENCE OR NONEXISTENCE COMPREHENSIVE DICTIONARY is broadcasted from 19:00 on Jun. 28, 2006, on the broadcast wave which can be received by the portable terminal apparatus 102. Therefore, the viewing reservation information shown in FIG. 11 is generated (S1403), and is stored in the viewing reservation information storing section 406.

If there is not the program for which the recording reservation has been made in the home recording apparatus 101, among programs which are viewable in the portable terminal apparatus 102, such an UI as enables the user to know that the recording reservation has been made at home may be able to be presented.

The viewing controlling section 407 refers to the viewing reservation information stored in the viewing reservation information storing section 406, and at 19:30 on Jun. 28, 2006 which is a viewing time instant, notifies the user from the viewing time notifying section 408 (S1404). Although the notification may be performed just at the start time, the user can view the program from the start if the notification is performed a little earlier.

If the viewing decision is inputted to the program selection displaying section 409 from the user (S1405), the broadcast is received and displayed (S1406).

By implementing as above, the viewing reservation can be made for the program for which the recording reservation has been made in the home recording apparatus 101, in the portable terminal apparatus 102. If the user is in a situation where a recording-reserved content can be viewed, the user can perform the viewing in real time by using a simulcast or a plurality of broadcast waves, without any complicated operation.

Moreover, in the present embodiment, the program name of the program for which the recording reservation has been made in the home recording apparatus 101, is searched for from data of the programs which are viewable in the portable terminal apparatus 102, and the viewing reservation is made therefor. However, in the case of the simulcast, only the channel and the broadcast time may be notified for making the viewing reservation without using the program name.

Moreover, in the present embodiment, the example has been described in which the program for which the recording reservation has been made in the home recording apparatus 101 is set as the viewing reservation in the portable terminal apparatus 102. However, conversely, the same mechanism can also be applied to implement setting of the program for which the viewing reservation has been made in the portable terminal apparatus 102, as the recording reservation in the home recording apparatus 101. In this case, the viewing reservation information in the portable terminal apparatus 102 may be transmitted to the home recording apparatus 101, and based on the information, the recording reservation may be made.

Next, the recording-viewing reservation system according to a second embodiment of the present invention will be described with reference to the drawings.

In the above described first embodiment, it is possible to make the viewing reservation for the program for which the recording reservation has been made in the home recording apparatus 101, in the portable terminal apparatus 102, and to perform the viewing without performing any cumbersome operation, in the case of being in an environment where a content to be recorded can be viewed. In the case where the viewing is interrupted while the program for which the viewing reservation has been made in the portable terminal apparatus 102 is being viewed, it is conceivable that it is desired to continue where interrupted when the program recorded in the home recording apparatus 101 is viewed. It is desired to perform an “already-viewed” processing also in the home recording apparatus 101, for the program which has been viewed to the end in the portable terminal apparatus 102. Furthermore, it may be considered that it is also desired to view the program recorded in the home recording apparatus 101, in the portable terminal apparatus 102.

A means which responds to such desires of the user will be described as a second mode of the present invention. The recording-viewing reservation system according to the present embodiment is characterized in that the recording reservation information in the home device is transmitted to the portable device, and based on the information, the viewing reservation is made in the portable device and when the viewing is performed, viewing time period information is used.

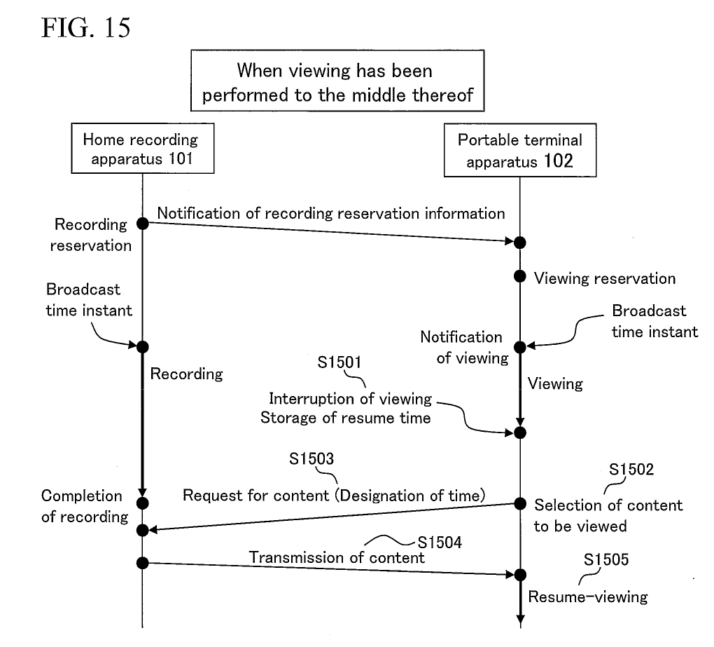

FIGS. 15 to 24 are diagrams showing techniques according to the present embodiment, which are methods of processing depending on a viewing status of the viewing-reserved program in the portable terminal apparatus 102. Descriptions of the same parts as the first embodiment are omitted.

FIG. 15 is a diagram showing a processing flow in the case where, while the viewing-reserved program is being viewed in the portable terminal apparatus 102, the viewing is interrupted. The viewing reservation is made for the program for which the recording reservation has been made in the home recording device 101, in the portable terminal apparatus 102, and the viewing is performed (similar to S101 to S105 of FIG. 2). When the viewing is interrupted while the viewing is performed, a time from the start of the program until the interruption is stored as an interruption time (S1501: INTERRUPTION OF VIEWING, STORAGE OF RESUME TIME).

Subsequently, if the user has attempted to view the above described program recorded in the home recording apparatus 101, in the portable terminal apparatus 102 (S1502), the portable terminal apparatus 102 issues a request for the above described content along with the interruption time, to the home recording apparatus (S1503). Based on the requested content and the interruption time, the home recording apparatus 101 transmits a part which is at and after the interruption time (which may also be a little earlier), of the recorded content, to the portable terminal apparatus 102 (S1504).

In the portable terminal apparatus 101, when an obtained content is played, resume-play from a time point when the viewing has been interrupted is performed (S1505). In other words, resume-viewing is enabled.

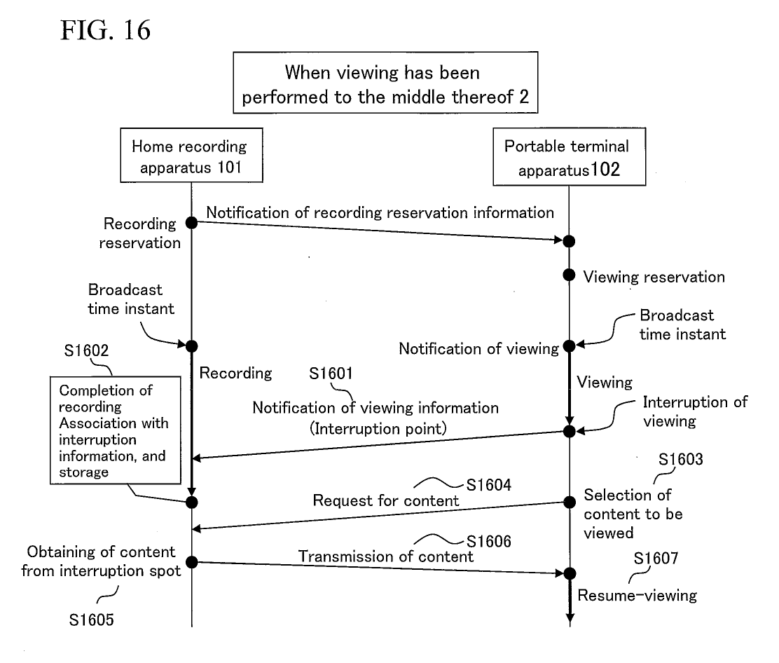

FIG. 16 is a flowchart diagram showing a processing flow for viewing the program of which the viewing has been interrupted, in the portable terminal apparatus 102, which is a processing for performing the viewing in a manner different from FIG. 15. If the broadcast of the program for which the recording reservation has been made in the home recording apparatus 101 has been viewed and interrupted in the portable terminal apparatus 102, the portable terminal apparatus 102 notifies that the viewing has been interrupted and notifies of a time when the interruption has been performed (S1601).

In the home recording apparatus 101, when the recording of the program is completed, the recorded program and the interruption time notified from the portable terminal apparatus 102 are associated with each other and saved (S1602). Subsequently, if the program being viewed is selected in the portable terminal apparatus 102 (S1603), and the request for the content is issued to the home recording apparatus 101 (S1604), the home recording apparatus 101 obtains the above described content which has been recorded, from an interruption point of time which can be obtained based on the above described notified interruption time (S1605), and transmits the content to the portable terminal apparatus 102 (S1606). Then, in the portable terminal apparatus 102, the viewing can be performed from the middle of the viewing (S1607).

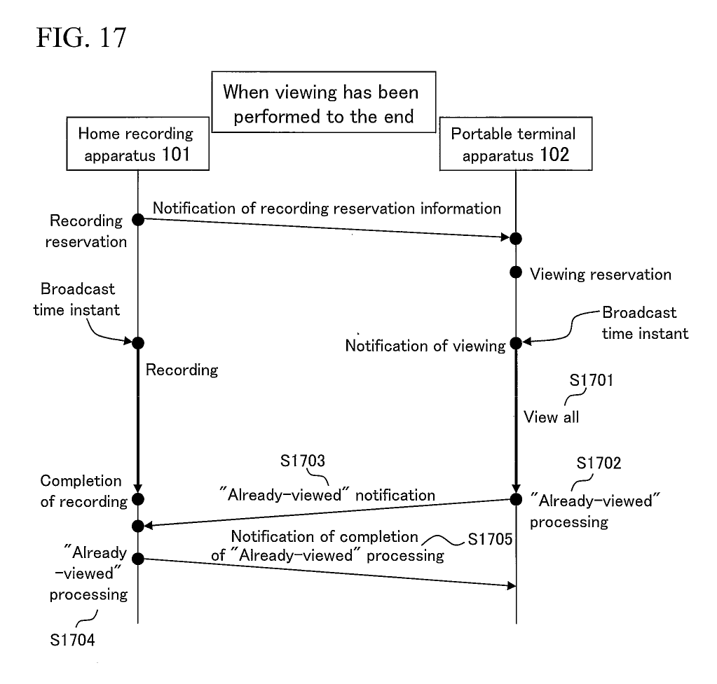

FIG. 17 is a diagram showing a processing flow in the case where the viewing-reserved program has been viewed to the end in the portable terminal apparatus 102. The viewing reservation is made for the program for which the recording reservation has been made in the home recording apparatus 101, in the portable terminal apparatus 102, and the viewing is performed (the processing similar to S101 to S105 of FIG. 2). When the program has been viewed to the end in the portable terminal apparatus 102 (S1701), the “already-viewed” processing is performed in the portable terminal apparatus 102 (S1702), and also, the home recording apparatus 101 is notified that the entire program of the recording reservation has been viewed (S1703).

In the home recording apparatus 101, if an “already-viewed” notification is received, the “already-viewed” processing is performed for the content (S1704). Here, the “already-viewed” processing in the portable terminal apparatus 102 includes a processing for deleting the information regarding the broadcast thereof, and a processing for setting a flag indicating that the viewing has already been performed, and thereby enabling identification thereof. In the home recording apparatus 101, similar setting of the flag indicating that the viewing has already been performed, and a processing for deleting recorded data itself are included.

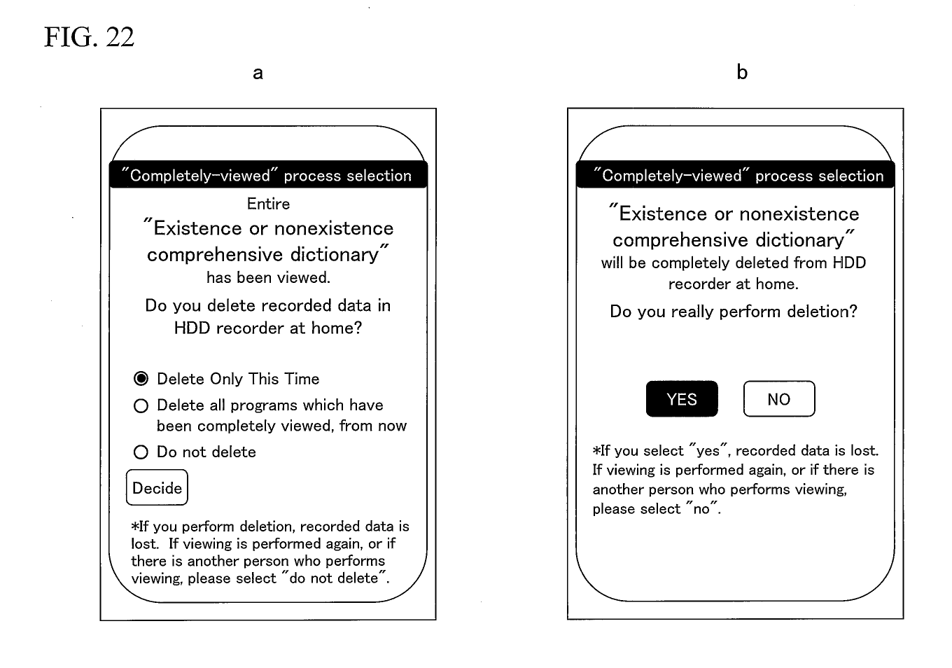

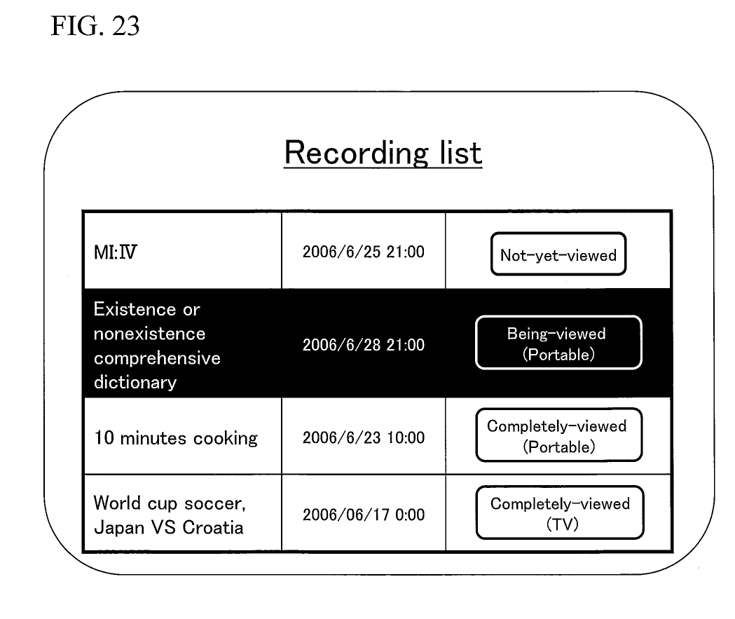

If the recorded data has been deleted, it is desired to notify the portable terminal that the deletion has been performed (S1705). Moreover, when the viewing has been performed, the user may be inquired whether or not to delete the recorded data in the home recording apparatus 101, and a result thereof may be included in the “already-viewed” notification and notified. An example of a screen which inquires whether or not to delete the recorded data is shown in FIG. 22, and an example of the recording list when the home recording apparatus 101 has been notified that the viewing has been completed is shown in FIG. 23.

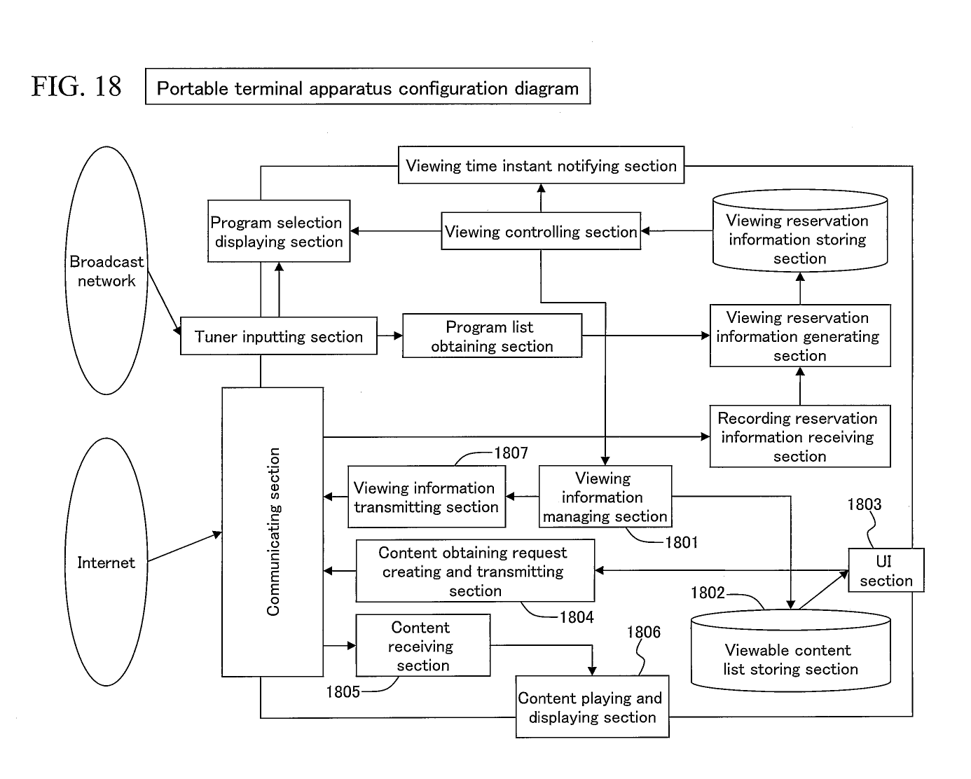

FIG. 18 is a functional block diagram showing a configuration example of the portable terminal apparatus 102 according to the present embodiment. In FIG. 18, only parts different from FIG. 4, which is a corresponding figure, are attached with reference numerals and described. A viewing information managing section 1801 shown in FIG. 18 manages a status where the viewing-reserved program has been viewed. If the viewing has been interrupted, viewable content information is created from both information required when the content is viewed next time (for example, content access information) and the interruption point of time, converted into a list, and stored in a viewable content list storing section 1802.

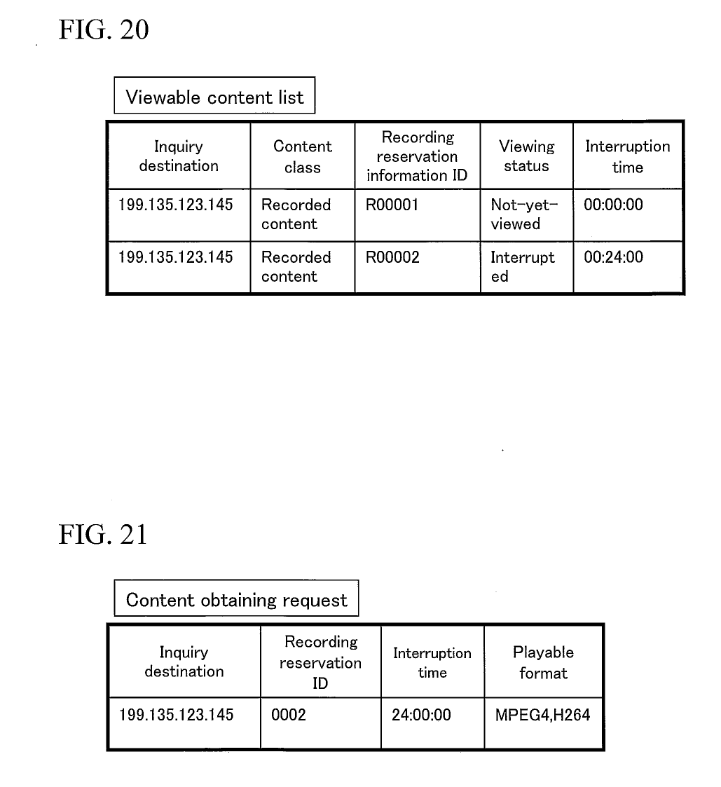

The viewable content list storing section 1802 stores a viewable information list created by the viewing information managing section 1801. An example of the viewable information list being stored is shown in FIG. 20, and details thereof will be described later. A UI section 1803 uses the viewable content information stored in the viewable content list storing section 1802, to present an UI with which the user selects the content, such as a viewable content table screen, to the user. Here, based on the recording reservation information ID in the viewable content information stored in a viewable content list, the recording time in the home recording apparatus 101 is checked, and only a content which has been completely recorded or a content which is being recorded and viewable may be presented to the user, or a content of which the recording time has not yet come and which is not viewable may be displayed so that it can be known. Moreover, in the UI section, a UI which inquires whether or not the content is to be deleted may be displayed.

A content obtaining request creating and transmitting section 1804 creates a request for obtaining a content which has been selected by the user via the content selection UI, and transmits the request to the home recording apparatus 101 via the communicating section. A content receiving section 1805 receives the content which has been requested from the content obtaining request creating and transmitting section 1804 to the home recording apparatus 101 and has been transmitted. An example of the content obtaining request is shown in FIG. 21, and details thereof will be described later. A content playing and displaying section 1806 displays the content received by the content receiving section 1805. A viewing information transmitting section 1807 notifies the home recording apparatus 101 of viewing information on the content which has been viewed, that is, information regarding whether or not the viewing has been performed and the viewing time, such as whether the viewing has been performed to the end, the viewing has been performed to the middle thereof, or the viewing has not yet been performed.

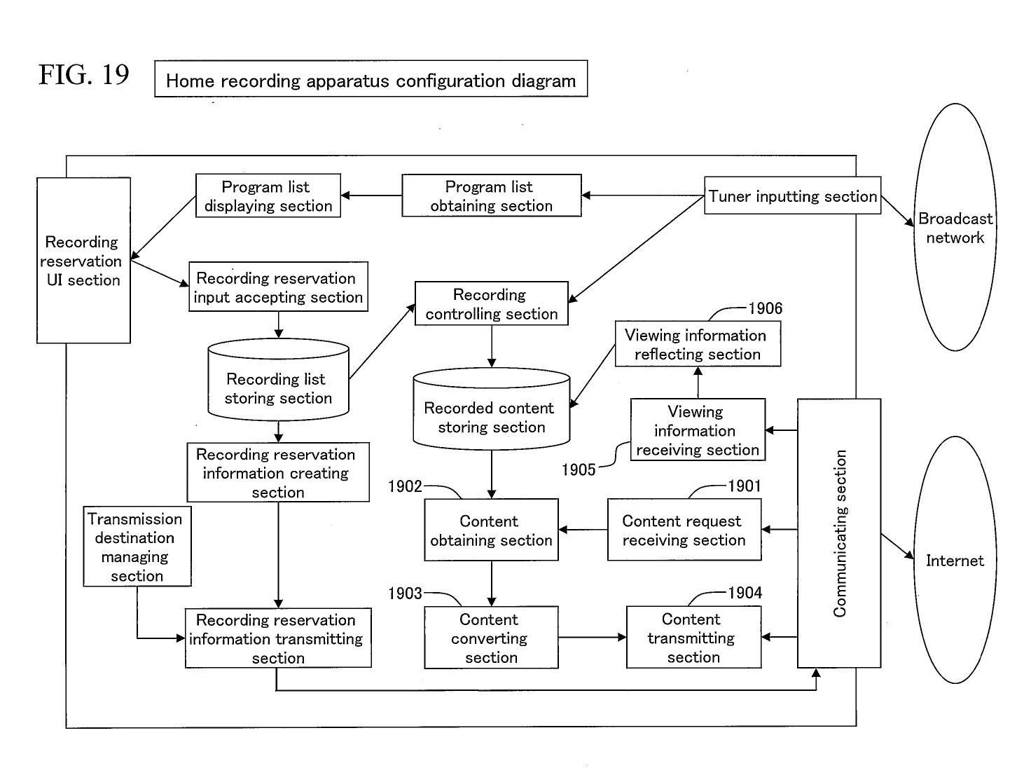

FIG. 19 is a diagram showing a configuration example of the home recording apparatus 101 in the present embodiment. Here, only parts added in comparison with FIG. 3 are attached with reference numerals and described. A content request receiving section 1901 receives the content request from the portable terminal apparatus 102, and transmits the information on the content to be obtained, to a content obtaining section 1902. FIG. 21 is a diagram showing an example of the content obtaining request. The content obtaining section 1902 obtains the content which has been transmitted from the content request receiving section 1901, and which has been requested from the portable terminal apparatus 102, from the recorded content storing section 310, and transmits the content to a content converting section 1903. If the interruption point of time has been attached to content request information, based on the interruption point of time, only a necessary part of the content stored in the content storing section 310 is extracted.

The content converting section 1903 converts the content obtained by the content obtaining section 1902 into a format playable by a playing device. A content transmitting section 1904 transmits the content converted by the content converting section 1903, to a transmitter of the content obtaining request. A viewing information receiving section 1905 receives information regarding a viewing status of the content which has been viewed in the portable terminal apparatus 102. As the viewing status, “the viewing has been interrupted”, “the viewing has been completely performed”, “the viewing has not yet been performed” and the like are conceivable. In the case of “the viewing has been interrupted”, time information showing how long the viewing has been performed may be included. In the home recording apparatus 101, this information regarding the viewing status can be used to display the viewing status in a table of the recorded contents, and provide a display which can be easily understood by the user. An example thereof is shown in FIG. 23 and will be described later.

According to the viewing information received by the viewing information receiving section 1905, a viewing information reflecting section 1906 performs a processing for the content stored in the recorded content storing section 310. The processing is performed so that, in the case of “the viewing has been interrupted”, association with the interruption point of time and saving are performed, and in the case of “the viewing has been completely performed”, a label of “completely-viewed” is attached or the deletion is performed. Moreover, the viewing information reflecting section 1906 may store the viewing information for each other party which has transmitted the viewing information, in an identifiable state.

FIG. 20 is a diagram showing an example of the viewable content list which has been stored in the viewable content list storing section in the portable terminal apparatus 102. In information shown in FIG. 20, information required for obtaining an appropriate content has been described. Here, an inquiry destination, a content class, the recording reservation information ID, the viewing status, and the interruption time are included. The inquiry destination represents an access destination for obtaining this content, such as an IP address, an email address or a URL. The content class is a method with which the content, such as the recorded content or a downloaded content, has been obtained, and may be used when the viewable content list is classified and presented to the user.

The recording reservation information ID is information corresponding to the recording reservation information ID of FIG. 8, and causes the viewable content list to correspond to the recording reservation list. Thereby, a more detailed viewable content list can be presented to the user. The viewing status includes “already-viewed”, “not-yet-viewed”, “interrupted” and the like, represents the status of the viewing, and is used when the presentation to the user is performed, when the content is requested, and the like. In the interruption time, the time at which the content has been interrupted when the content has been viewed before, has been described.

FIG. 21 shows information required for the content obtaining request which is created and transmitted by the content obtaining request creating and transmitting section 1804. The recording reservation ID is one ID which has been assigned to each one recording reservation in the home recording apparatus 101, and can be used to determine which recorded content is indicated. The interruption time is time information showing what time corresponds to a part from which the transmission needs to be performed when the content is transmitted, and here, is just 24 o'clock which is the interruption time.

A playable format is a field in which a type of a format playable by the portable terminal apparatus 102 is described. Thereby, the playable format is used for converting the obtained content into the format playable by the portable terminal apparatus 102 in which the viewing is performed, by the content converting section 1903.

FIG. 22 is a diagram showing an example of a display screen of the displaying section which, when the viewing of the recorded content has been completed in the portable terminal apparatus 102, inquires of the user whether or not to delete the recorded content which has been stored in the home recording apparatus 101. If the entire “EXISTENCE OR NONEXISTENCE COMPREHENSIVE DICTIONARY” has been viewed, “a” notifies to that effect and also inquires whether or not to delete the recorded data in the HDD recorder at home. The user can select and decide from “DELETE ONLY THIS TIME”, “DELETE ALL PROGRAMS WHICH HAVE BEEN COMPLETELY VIEWED, FROM NOW” and “DO NOT DELETE”. If “DELETE ONLY THIS TIME” is selected, the recorded data of “EXISTENCE OR NONEXISTENCE COMPREHENSIVE DICTIONARY” which has just been completely viewed is deleted from the home recording apparatus 101. If “DELETE ALL PROGRAMS WHICH HAVE BEEN COMPLETELY VIEWED, FROM NOW” is selected, when the recorded content in the home recording apparatus 101 is viewed to the end in the portable terminal apparatus 102 next time or later, the recorded data in the home recording apparatus 101 is automatically deleted. If “DO NOT DELETE” is selected, the recorded data in the home recording apparatus 101 is not deleted, and can be viewed by another family member or viewed again. As shown in FIG. 22, it is preferable to indicate such a comment that the deletion had better not be performed if the viewing is performed again or if another person performs the viewing. Furthermore, if “DELETE ONLY THIS TIME” or “DELETE ALL PROGRAMS WHICH HAVE BEEN COMPLETELY VIEWED, FROM NOW” has been selected, in order to prevent erroneous operations, as shown in “b”, it is desirable to provide a display which confirms again whether or not the deletion may be really performed.

FIG. 23 is a diagram showing an example of a screen which displays the table of the recorded contents which have been stored in the recorded content storing section 310 in the home recording apparatus 101. The viewing status which has been reflected into the recorded program by the viewing information reflecting section 1906 is displayed so that the user can know the viewing status. In this example, the display is provided so that it can be known whether the viewing status is “not-yet-viewed”, “being-viewed” or “completely-viewed”. Furthermore, in the case of “being-viewed” or “completely-viewed”, the display is provided so that it can be known in which viewing apparatus, such as the portable terminal apparatus or the television (TV), the viewing has been performed. Instead of a type of the viewing apparatus, a type of the broadcast wave such as the one-seg or the digital terrestrial may be displayed, icons representing them may be used, or a combination thereof may be displayed.

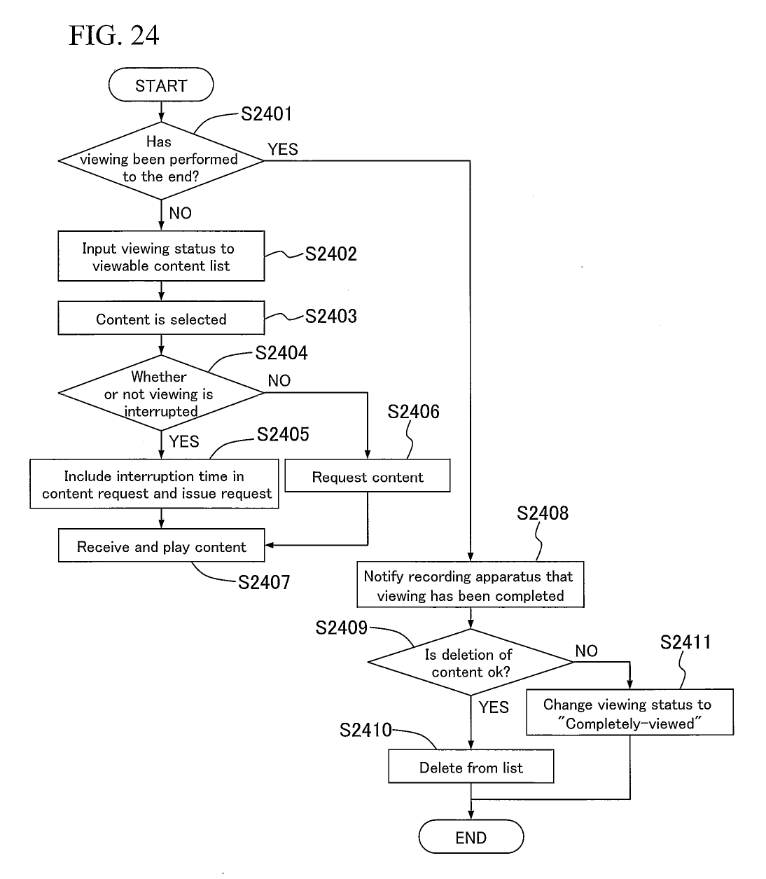

FIG. 24 is a flowchart diagram in the case where a processing is performed depending on the status of the viewing of the program for which the recording reservation has been made in the home recording apparatus 101 and for which the viewing reservation has been made in the portable terminal apparatus 102, in the present embodiment. Hereinafter, along with a description of the procedure, an example in the case where, while “EXISTENCE OR NONEXISTENCE COMPREHENSIVE DICTIONARY” illustrated in the first embodiment is being viewed, the viewing is interrupted, will be specifically described.

In the viewing information managing section 1801 in the portable terminal apparatus 102, it is judged whether or not the program being viewed has been viewed to the end (S2401). If the viewing has not been performed to the end, the viewing information managing section 1801 inputs the viewing status and the interruption time of the above described content into the viewable content list stored in the viewable content list storing section 1802 (S2402). As the viewing status, “not-yet-viewed”, “interrupted”, “completely-viewed” and the like are conceivable.

Since the viewing has been interrupted after 24 minutes from the start of the broadcast of EXISTENCE OR NONEXISTENCE COMPREHENSIVE DICTIONARY, as shown in FIG. 20, the viewing status is set to “interrupted” and the interruption time is set to 00:24:00, and the IP address of the home recording apparatus 101, the recording reservation information ID of EXISTENCE OR NONEXISTENCE COMPREHENSIVE DICTIONARY, and a fact that EXISTENCE OR NONEXISTENCE COMPREHENSIVE DICTIONARY is the recorded content are stored.

The UI section 1803 presents the UI with which the user selects the content to be viewed, from the viewable content list stored in the viewable content list storing section 1402, and based on the viewing status in the viewable content list, the contents can be classified into types such as “content which has already been viewed”, “content which has not yet been viewed” and “content in the middle of being viewed”, and presented.

Although “EXISTENCE OR NONEXISTENCE COMPREHENSIVE DICTIONARY” is classified as the content in the middle of being viewed, according to the first embodiment, “EXISTENCE OR NONEXISTENCE COMPREHENSIVE DICTIONARY” is broadcasted from 19:00 in the portable terminal apparatus 102 and from 21:00 in the home recording apparatus 101, and thus may be displayed in the content selection UI at and after 21:00, or information showing that the viewing still cannot be performed and showing what time the viewing can be performed from may be displayed first. Then, when the content is selected by the user, the UI section 1803 passes information on the selected viewable content to the content obtaining request creating and transmitting section 1804 (S2403).

In the content obtaining request creating and transmitting section 1804, it is judged whether or not the viewing status of the passed viewable content is “interrupted” (S2404), and if the viewing status is “being-interrupted” (YES), the content obtaining request including the interruption time is generated (S2405). On this occasion, as shown in FIG. 21, the IP address of the home recording reservation apparatus as the inquiry destination for the content, 0002 which is the recording reservation ID in the home recording apparatus 101 and which exists in the recording reservation information since the recording reservation information ID in the viewable content list is R00002, the interruption time, and ABC which is a model of the portable terminal 101, are attached to the content obtaining request, and the content obtaining request is transmitted from the communicating section 308.

If the viewing status is not “being-interrupted” (NO), that is, if the viewing has not yet been performed, the content obtaining request generating and creating section 1804 transmits the content obtaining request without designating the interruption time (S2406).

In each case, if the content is transmitted from the home recording apparatus 101, the content is received by the content receiving section 1805 and played by the content playing and displaying section 1806 (S2407). If it has been determined in a processing in S2401 that the viewing has been performed to the end (YES), the viewing information transmitting section 1807 notifies the home recording apparatus 101 that the content has been completely viewed (S2408). In the home recording apparatus 101, the reception is performed by the viewing information receiving section 1905, and the viewing information reflecting section 1906 performs the “already-viewed” processing for the recorded content.

Next, in the portable terminal apparatus 102, the user is inquired whether or not the content may be deleted, by the UI section 1803 (S2409). If the deletion has been approved (YES), the information on the content is erased from the viewable content list (S2410). Here, if the deletion is approved, information showing that the deletion is possible may be transmitted to the home recording apparatus 101, and the content itself recorded in the home recording apparatus 101 may be deleted. If the deletion has not been approved (NO), the viewing status of the content in the viewable content list is changed to “completely-viewed” (S2411). Then, when the table of the contents is displayed or the like, “completely-viewed” is presented, and thereby the user can easily comprehend the viewing status of the content.

Moreover, the deletion from the viewable content list may be automatically performed without making the inquiry about the deletion in S2409, or a mark of “already-viewed” may be attached. Although details are not described, when the present example is implemented, the followings may be considered.

In the second embodiment, in the case where the viewing has been interrupted, when the viewing is performed next time, the content is requested with an interruption point being designated. However, at the time point when the viewing has been interrupted, the home recording apparatus 101 may have been notified thereof, the recorded content and the user who has interrupted the viewing may have been caused to correspond to each other and stored, the portable terminal apparatus 102 may issue only the request for the content, and the home recording apparatus 101 may transmit the content which is at and after the interruption point of time.

Before the viewing is performed in the portable terminal apparatus 102, the recorded content in the home recording apparatus 101 may be deleted. In this case, the portable terminal apparatus may be notified that the deletion has been performed, and in the portable terminal apparatus 101, the deletion from the viewable content list may be performed, or the viewing status may be set to “deleted” and presented to the user.

Moreover, it is also conceivable that the recording reservation made in the home recording apparatus 101 is canceled before the recording is performed. In this case, the portable terminal apparatus 102 may be notified thereof and the viewing reservation may be canceled. Alternatively, even if the notification is performed, the viewing reservation may be kept unchanged, and may not be entered in the viewable content list when the viewing has not been performed. Moreover, the user may be inquired about the cancel of the viewing reservation.

Moreover, a situation is also conceivable in which, although the recording reservation has been made in the home recording apparatus 101 and the viewing reservation has been made in the portable terminal apparatus 102, the viewing reservation is canceled in the portable terminal apparatus 102. In that case, the home recording apparatus 101 may be notified thereof so as to enable the cancel of the recording reservation, or may not be done.

Moreover, when the content being viewed is transmitted to the portable terminal apparatus 102, first, a digest of a part which has already been viewed may be created and transmitted, and subsequently, the content which is at and after the interruption point may be transmitted. Moreover, in the present example, the home recording apparatus 101 and the portable terminal apparatus 102 are directly connected to each other via the Internet. However, it may be configured so that a server is provided between them to serve as an intermediary for the transmission and reception of the content, the transmission and reception of the recording reservation information, and the like.

Next, the system according to a third embodiment of the present invention will be described with reference to the drawings. In the above described first and second embodiments, the example has been described in which the recording reservation information in the home recording apparatus 101 is transmitted to the portable terminal apparatus 102, and in the portable terminal apparatus 102, the viewing reservation is created based on the program list. In the third embodiment, an example will be described in which the creation of the viewing reservation is also performed in the home recording apparatus 101, and the viewing reservation information is transmitted to the portable terminal apparatus 102.

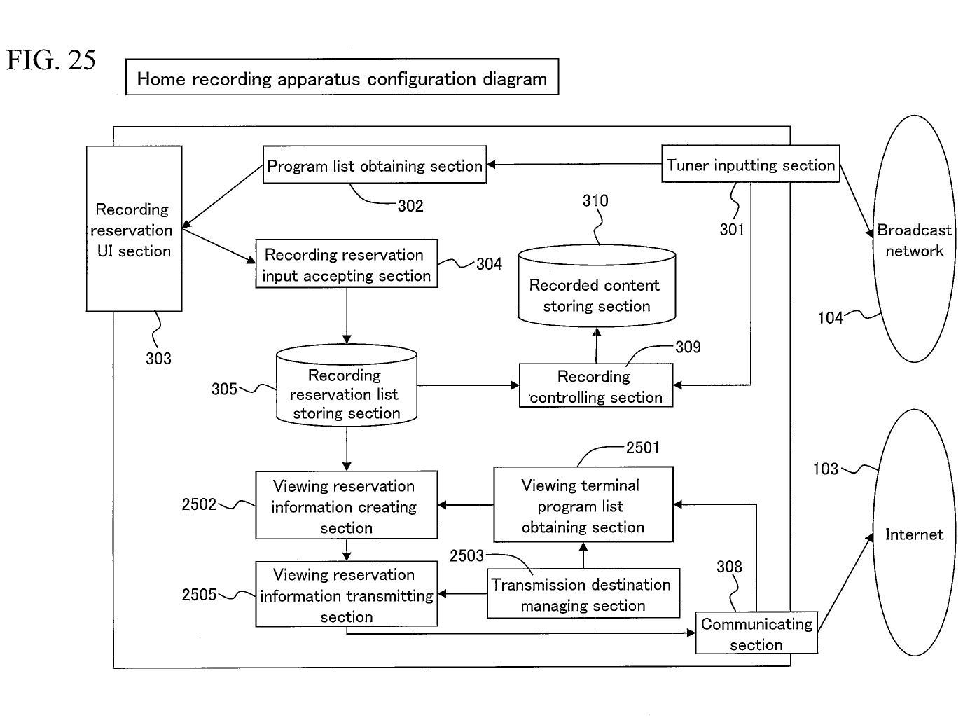

FIG. 25 is a diagram showing a configuration example of the home recording apparatus 101 according to the present embodiment. A viewing terminal program list obtaining section 2501 obtains information on a broadcast wave which is viewable in a terminal of the other party to which the viewing reservation information is transmitted, from a transmission destination managing section 2503, and obtains the program list data of the broadcast wave 104 from the Internet 103 via the communicating section. A viewing reservation information creating section 2502 creates the viewing reservation information in the terminal at the transmission destination, from the inputted recording reservation information. In the transmission destination managing section 2503, an address of the transmission destination and the broadcast wave which is viewable in the terminal at the transmission destination are managed.

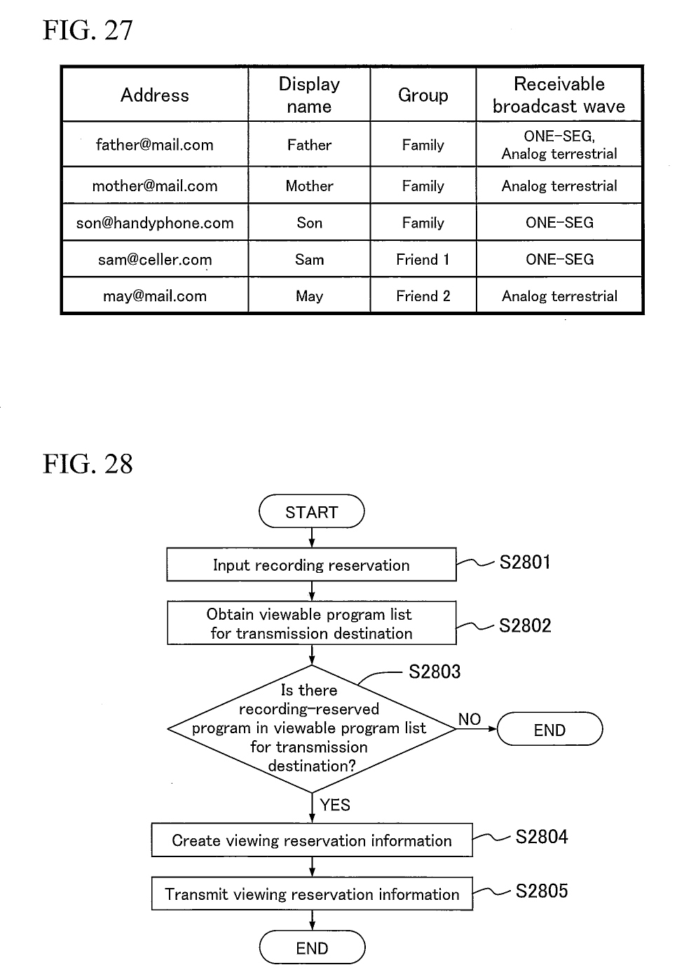

An example of the managed information is shown in FIG. 27. In addition to FIG. 9, management of information including data regarding which broadcast wave such as the one-seg or the analog terrestrial broadcast can be received for each address is performed. A viewing reservation information transmitting section 2504 transmits the viewing reservation information created by the viewing reservation information creating section 2502, to the portable terminal apparatus 102 via the communicating section 306.

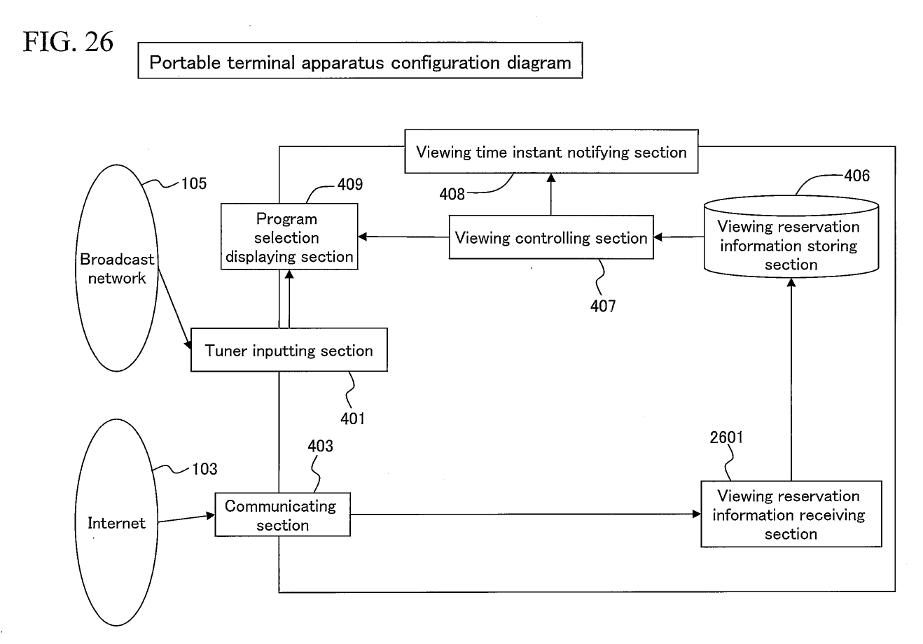

FIG. 26 is a diagram showing a configuration example of the portable terminal apparatus 102 according to the present embodiment. In comparison with the configuration of FIG. 4, the recording reservation information receiving section has been replaced with a viewing reservation information receiving section 2601, and the viewing reservation information creating section and the program list obtaining section have been deleted. The viewing reservation information receiving section 2601 receives the viewing reservation information transmitted from the home recording apparatus 101, and saves it in the viewing reservation information storing section 406. The recording reservation information receiving section or the program list obtaining section may also be provided, and if the viewable program list for the portable terminal apparatus 102 is not able to be obtained in the home recording apparatus 101, similarly to the first embodiment, the recording reservation may be received in the portable terminal apparatus 102 and the viewing reservation may be created.

FIG. 28 is a flowchart diagram showing a processing example in the home recording apparatus 101 according to the present embodiment. If the recording reservation is inputted according to a procedure of S1301 to S1303 of FIG. 13 (S2801), the viewing terminal program list obtaining section 2501 obtains the program list data of the broadcast wave which is viewable in the transmission destination managed by the transmission destination managing section 2503, from the Internet via the communicating section 308 (S2802).

Next, in the viewing reservation information creating section 2502, it is determined from the obtained program list whether or not there is the recording-reserved program (S2803), and if there is the recording-reserved program, the viewing reservation information in the portable terminal apparatus at the transmission destination is generated (S2804). Then, the viewing reservation information transmitting section 2505 transmits the viewing reservation information to the address of the other party destination managed by the transmission destination managing section 2503 (S2805).

If the program list has not been able to be obtained, if the broadcast wave which is viewable in the transmission destination has not been set in the transmission destination managing section 2503, or if there is not the recording-reserved program in the viewable program list for the terminal at the transmission destination, the viewing reservation information may not be created and the transmission destination may not be notified of anything, or similarly to the first embodiment, the recording reservation information may be transmitted. In the portable terminal apparatus 102, when the viewing reservation information is received, the viewing reservation information is added to the viewing reservation list, and the user can view the program for which the recording reservation has been made in the home recording apparatus 101, at the broadcast time of the program without effort.

It should be noted that the portable terminal apparatus 102 may have a function capable of, when the viewing-reserved program is viewed, using an infrared communication, a wireless network or the like to instruct a TV, a display or the like at the going-out destination to start the viewing. Thereby, the user can also view a desired program on a large TV at the going-out destination, without performing any troublesome operation. For example, regardless of whether or not the portable terminal apparatus 102 itself has the function of viewing the broadcast program, the portable terminal apparatus 102 may instruct, for example, a device (such as the TV) which is installed at the going-out destination and in which the broadcast program can be viewed, to start the viewing so as to enable the user to view the broadcast program on the TV or the like at the going-out destination.

As described above, according to the viewing system according to the respective embodiments of the present invention, there is an advantage in that the recording-reserved broadcast program can also be easily viewed at a remote location.

### INDUSTRIAL APPLICABILITY

The present invention is applicable to the recording-viewing reservation system. Moreover, the present invention is also applicable as a remote viewing system.

1-21. (canceled)

22. A terminal apparatus characterized by comprising:
a video displaying and audio outputting section which receives a broadcast program, and displays video or outputs audio of said received program; and
a viewing reservation creating section which receives information which is capable of identifying the broadcast program and is regarding a recording reservation in a device of a transmitter, and creates a viewing reservation for said broadcast program based on said information regarding the recording reservation.

23. The terminal apparatus according to claim 22, characterized in that:
said video displaying and audio outputting section receives a specific broadcast program based on said created viewing reservation, and displays video or outputs audio of said received broadcast program.

24. The terminal apparatus according to claim 23, characterized by comprising:
a viewing notifying section which notifies a viewer that a viewing time instant has come close, based on said created viewing reservation.

25. The terminal apparatus according to claim 23, characterized by comprising:
a viewing information transmitting section which notifies the transmitter of said information regarding the recording reservation, of viewing information on the video displayed or the audio outputted by said video displaying and audio outputting section.

26. The terminal apparatus according to claim 22, characterized in that:
said terminal apparatus comprises:
a viewable content list storing section which stores a viewable content list for the terminal itself;
a section which uses said viewable content list to create a user interface which displays a content selection screen on which a user selects a content to be viewed; and
a content obtaining request creating and transmitting section which creates a content obtaining request for obtaining the content selected on said displayed content selection screen, and transmits the content obtaining request to an obtaining destination of said content, and
said video displaying and audio outputting section obtains the content requested in said transmitted content obtaining request, from said obtaining destination, and displays video or outputs audio of said obtained content.

27. The terminal apparatus according to claim 26, characterized in that:
said content obtaining request includes a start point of a content desired to be obtained.

28. A terminal apparatus characterized by comprising:
a video displaying and audio outputting section which receives a broadcast program, and displays video or outputs audio of said received program; and
a viewing reservation information receiving section which receives viewing reservation information which specifies a broadcast program which is viewable in the terminal itself.

29. The terminal apparatus according to claim 28, characterized in that:
said video displaying and audio outputting section receives a specific broadcast program based on the viewing reservation information received by said viewing reservation information receiving section, and displays video or outputs audio of said broadcast program.

30. A recording apparatus characterized by comprising:
a recording-reserving section which makes a recording reservation for a broadcast program;
an address managing section which manages an address of the other party destination to which information regarding the recording reservation, which can identify said recording-reserved broadcast program, is transmitted;
a recording reservation information transmitting section which transmits said information regarding the recording reservation to a device having the address managed by said address managing section;
a recording section which receives and records the broadcast program based on said information regarding the recording reservation; and
a recorded content storing section which stores said recorded broadcast program as a content,
the recording apparatus being characterized in that said device having the address managed by said address managing section includes a terminal apparatus characterized by comprising:
a video displaying and audio outputting section which receives a broadcast program, and displays video or outputs audio of said received program; and
a viewing reservation creating section which receives information which is capable of identifying the broadcast program and is regarding a recording reservation in a device of a transmitter, and creates a viewing reservation for said broadcast program based on said information regarding the recording reservation.

31. The recording apparatus according to claim 30, characterized by comprising:
a viewing information receiving section which receives viewing information including a viewing status of said recorded broadcast program in said device having the managed address; and
a viewing information reflecting section which performs a processing for reflecting said viewing information into said stored content, based on said received viewing information.

32. The recording apparatus according to claim 31, characterized in that:
if said received viewing information includes information meaning a interruption of viewing of the broadcast program, said viewing information reflecting section associates said information meaning the interruption of the viewing, with the content which is stored in said recorded content storing section and is corresponding to said broadcast program.

33. A recording apparatus characterized by comprising:
a recording-reserving section which makes a recording reservation for a broadcast program;
an address managing section which manages an address of the other party destination to which information regarding the recording reservation, which can identify said recording-reserved broadcast program, is transmitted;
a recording reservation information transmitting section which transmits said information regarding the recording reservation to a device having the address managed by said address managing section;
a recording section which receives and records the broadcast program based on said information regarding the recording reservation;
a recorded content storing section which stores said recorded broadcast program as a content;
a viewing information receiving section which receives viewing information including a viewing status of said recorded broadcast program in said device having the managed address; and
a viewing information reflecting section which performs a processing for reflecting said viewing information into said stored content, based on said received viewing information, the recording apparatus being characterized in that:
if said received viewing information includes information meaning completion of viewing of the broadcast program, said viewing information reflecting section associates said information meaning the completion of the viewing, with the content which is stored in said recorded content storing section and is corresponding to said broadcast program.

34. The recording apparatus according to claim 33, characterized in that:
if said received viewing information includes information meaning completion of viewing of the broadcast program, said viewing information reflecting section deletes the content which is stored in said recorded content storing section and is corresponding to said broadcast program.

35. The recording apparatus according to claim 31, characterized in that:
said viewing information reflecting section performs a processing for reflecting said viewing information into the content which is stored in said recorded content storing section and is corresponding to said broadcast program, for each transmitter address.

36. The recording apparatus according to claim 30, characterized by comprising:
a content obtaining request receiving section which accepts a request for obtaining the content stored in said recorded content storing section;
a content obtaining section which obtains the content stored in said recorded content storing section, based on said received content obtaining request;
a content converting section which converts said obtained content into a form which is playable in the other party destination which has issued said content obtaining request, the form having been previously registered or obtained by said content obtaining request receiving section; and
a content transmitting section which transmits said converted content to said other party destination.

37. The recording apparatus according to claim 36, characterized in that:
if the content obtaining request received by said content obtaining request receiving section includes a time when the obtaining of the content is started, said content obtaining section performs a content obtaining processing with reference to a point corresponding to said time when the obtaining of the content is started.

38. A recording apparatus characterized by comprising:
a recording-reserving section which makes a recording reservation for a broadcast program;
an address managing section which manages an address of the other party destination to which information regarding the recording reservation, which can identify said recording-reserved broadcast program, is transmitted;
a transmission destination device viewable program information obtaining section which obtains information on a program which is viewable in a device having the address managed by said address managing section;
a transmission destination device viewing reservation information creating section which creates viewing reservation information with which a viewing reservation can be made in a transmission destination device, based on both said information regarding the recording reservation and the program obtained by said transmission destination device viewable program information obtaining section; and
a viewing reservation information transmitting section which transmits the viewing reservation information created by said transmission destination device viewing reservation information creating section, to a destination managed by said address managing section,
the recording apparatus being characterized in that said device having the address managed by said address managing section includes a terminal apparatus characterized by comprising:
a video displaying and audio outputting section which receives a broadcast program, and displays video or outputs audio of said received program; and
a viewing reservation creating section which receives information which is capable of identifying the broadcast program and is regarding a recording reservation in a device of a transmitter, and creates a viewing reservation for said broadcast program based on said information regarding the recording reservation.

39. A viewing method characterized by comprising the steps of:
receiving information regarding a recording reservation, which can identify a broadcast program for which the recording reservation has been made in a recording apparatus;
performing comparison with an electronic program list retained in itself, based on said information regarding the recording reservation, and making a viewing reservation for the same broadcast program as the recording-reserved program; and
at a broadcast time of said same broadcast program as the recording-reserved program, annunciating that a viewing time has come.

40. A viewing method characterized by comprising the steps of:
making a viewing reservation for a program for which a recording reservation has been made in a recording device, in a portable terminal apparatus;
while viewing is performed, if the viewing is interrupted, storing a time from the start of the program until the interruption, as an interruption time;
issuing a request for a content along with the interruption time, to a recording apparatus; and
based on the requested content and the interruption time, the recording apparatus receiving at least a part which is at and after the interruption time, of a recorded content, and performing resume-play from a time point when the viewing has been interrupted.

41. A program which causes a computer to execute steps according to claim 39.

42. A program which causes a computer to execute steps according to claim 40.
